(19) United States
(12) Patent Application Publication
(10) Pub. No.: US 2024/0177453 A1
(43) Pub. Date: May 30, 2024

(54) Method and apparatus for assigning image areas from image series to result classes by means of analyte data evaluation system with processing model

(71) Applicant: Carl Zeiss Microscopy GmbH, Jena (DE)

(72) Inventors: Manuel AMTHOR, Jena (DE); Daniel HAASE, Zoellnitz (DE)

(21) Appl. No.: 18/519,239

(22) Filed: Nov. 27, 2023

(30) Foreign Application Priority Data
Nov. 28, 2022 (DE) 1020221314421

(51) Int. Cl. G06V 10/764; G06V 10/82

(52) U.S. Cl. CPC G06V 10/764; G06V 10/82

(57) ABSTRACT

A method for assigning image areas of an image series to result classes by means of a processing model that was trained to assign image areas from the image series to a result class. The image series is generated by marking analytes with markers in a plurality of coloring rounds and detecting the markers with a camera. The camera captures or acquires an image of the image series in each coloring round, and the markers are selected in such a way that the signal series of analytes in an image area across the image series include colored signals and uncolored signals. The colored and uncolored signals of the analyte signal series have at least one particular ratio of one of the colored and/or uncolored signals of the respective signal series.

The present invention relates to a method and an apparatus for training a machine learning system with a processing model, wherein the processing model is trained to assign a result class to signal series of image areas from an image series, a method and an apparatus for training a machine learning system with a candidate extraction model for extracting candidate signal series from an image series, and a method and an apparatus for assigning image areas from an image series to result classes by means of an analyte data evaluation system with a processing model, wherein the processing model has been trained to assign a result class to image areas from the image series.

EP 2 992 115 B1 describes a method for identifying analytes by coloring the analytes to be identified with markers in a plurality of coloring rounds. The markers consist of oligonucleotides and dyes coupled thereto, which are generally fluorescent dyes. The oligonucleotides are specific for certain sections of the analytes to be identified. The individual oligonucleotides of the markers, however, are not unique to the particular analytes. But due to the plurality of coloring rounds, it is possible to clearly identify the analytes because a plurality of different markers can be assigned to a specific oligonucleotide after the plurality of coloring rounds has been completed, making the assigned markers unique to the respective analytes.

This method can be used to detect a wide variety of analytes in vitro, for example in a cell, with the help of a fluorescence microscope. The analytes can be an RNA, in particular an mRNA or a tRNA. The analytes can also be a section of a DNA.

A sample often comprises a plurality of analytes that can be identified in parallel with the coloring rounds described above, even if they are different analytes. The more analytes there are in the sample, the greater the number of markers to be detected in the respective coloring rounds. In the case of an automatic capture and evaluation of the corresponding image signals, the image signals of all markers in the sample must be captured and likewise distinguished from image signals in the sample not caused by markers coupled to analytes.

WO 2020/254519 A1 and WO 2021/255244 A1 describe a further method that can be used, among other things, to identify not only analytes, but proteins as well. In this method, probes specific to the respective analytes are first coupled to said analytes. The probes have oligonucleotide residues that do not hybridize with the analytes. Decoding oligonucleotides are hybridized with the free oligonucleotide residues and have a supernatant to the free residues. Using a dye, marker molecules, or markers for short, are hybridized at the supernatants. In this method as well, a series of image signals is generated on the corresponding analytes in a plurality of coloring rounds, which then provide information about the analyte present in each case. Other methods are known as well, however, in which the markers bind directly to the free oligonucleotide residues.

In practice, it has turned out that the amount of data required to write the image signals of the plurality of coloring rounds can amount to several terabytes. Processing such large amounts of data requires a correspondingly large amount of memory. The resulting acquisition and maintenance costs are therefore high. For data storage, SSD hard disks are preferably used, which on the one hand, are suitable for storing such large amounts of data and on the other hand, allow for fast data access. SSD hard disks only allow a limited number of write cycles, however. With such large amounts of data, this limit is quickly reached, which can cause a system failure. Furthermore, the analysis of such large amounts of data requires a correspondingly high computing power, or the analysis takes a correspondingly long time and users have to wait a long time for a result of their experiment.

### SUMMARY OF THE INVENTION

The object of the invention is to provide an improved method for assigning result classes, comprising analyte types, to image areas in image series in which analytes are marked with markers.

A further object of the invention is to provide a method for training a machine learning system with a processing model for assigning result classes to image areas in image series.

One aspect of the invention relates to a method for training a machine learning system with a processing model. The processing model is trained to assign a result class to signal series of image areas from an image series. The image series is generated by marking analytes with markers in a plurality of coloring rounds and detecting the markers with a camera. The camera captures an image of the image series in each coloring round. The markers are selected in such a way that the signal series of analytes in an image area across the image series include colored signals and uncolored signals. The colored and uncolored signals of the analyte signal series have at least one particular ratio of one of the colored and/or uncolored signals of the respective signal series to at least one other of the colored and/or uncolored signals of the respective signal series, or the analyte signal series have a characteristic signature comprising the at least one particular ratio. The method comprises a step of “providing an annotated data set”, wherein the annotated data set comprises input signal series for various result classes to be identified, and corresponding target outputs. The result classes comprise at least one class for each analyte type to be identified. The analyte signal series have a specific order of colored and uncolored signals, based on which an analyte type can be assigned to the signal series. The method further comprises a step of optimizing an objective function by adjusting the model parameters of the processing model, wherein the objective function is calculated based on a result output from the processing model and the target output.

According to the present invention, an analyte is an entity the presence or absence of which is to be specifically detected in a sample and which, if present, is to be coded. This may be any type of entity that is of interest, including a protein, a polypeptide, a protein molecule, or a nucleic acid molecule (e.g., RNA, PNA, or DNA), also called a transcript. The analyte provides at least one site for a specific binding with analyte-specific probes. An analyte in accordance with the invention comprises a complex of items, e.g., at least two individual nucleic acid molecules, protein molecules, or peptide molecules. In one embodiment of the disclosure, an analyte excludes a chromosome. In another embodiment of the disclosure, an analyte excludes DNA. In some embodiments, an analyte can be a coding sequence, a structural nucleotide sequence, or a structural nucleic acid molecule that refers to a nucleotide sequence that is translated into a polypeptide, typically via mRNA, when under the control of appropriate regulatory sequences. The boundaries of the coding sequence are determined by a translation start codon at the 5′ terminus and a translation stop codon at the 3′ terminus. A coding sequence can include, but is not limited to, genomic DNA, cDNA, EST, and recombinant nucleotide sequences. Depending on what analyte type is to be identified, such methods are referred to as spatial transcriptomics or also multiomics.

In the following, the term image signal is intended to refer either to a value of a pixel of the image for a specific color of a predetermined color channel, or the image signal comprises values of different basic colors of a color space of a colored image.

In the following, the term signal series is understood to mean a series of image signals of an image area across the coloring rounds. The image signals of a signal series can be acquired in an experiment. The image signals of a signal series can also, however, be generated artificially, for example for training purposes, for example by means of a suitable simulation or generative models.

According to the present invention, the spectral ranges, each comprising one color of a marker, are also referred to as color channels. The images separated into the color channels are mono-chromatic images and contain for every individual pixel the image signal of the pixel described above in the color of the color channel as a value or measured value.

The inventors have realized that signal series of image areas that capture image signals from analytes each have at least one particular ratio of colored and/or uncolored signals from the respective signal series across the signal series. Accordingly, signal series originating from analytes comprise a characteristic signature with the at least one particular ratio of the colored and/or uncolored signals of the signal series. Furthermore, for each of the analyte types to be identified, the analyte signal series have a particular sequence of colored and uncolored signals, based on which the analyte signal series can be assigned to an analyte type. Due to the fact that, according to the method for training a machine learning system, a processing model with signal series comprising colored and uncolored signals with the particular ratio or the characteristic signature, respectively, and the specific sequence of colored and uncolored signals, is trained to identify an analyte type, it is possible to provide a very effective, fast, and well-controlled method for training a machine learning system with a processing model that assigns a result class to signal series from image areas from an image series. A machine learning system trained in this manner can analyze the data of an image series with marked analytes in a very efficient manner.

Preferably, the processing model is, for example, a neural network, a convolutional neural network (CNN), a multi-layer perceptron (MLP), a recurrent neural network (RNN), or a transformer network.

Preferably, the annotated data set further comprises signal series from background image areas, wherein the background image areas are image areas from the image series in which no signals from analytes are captured, and the target output for the background image areas forms at least one class of its own in the set of result classes.

The background image areas can be divided into different types of background areas according to the present invention. On the one hand, there are background image areas, so-called analyte-free background image areas, in which no analytes can be located from the outset because, for example, there are no cells with analytes at the locations in the sample. In addition, there are also background areas where analytes could in fact potentially be located, but none are found or none have been detected in the current sample. These image areas can also be called analyte background image areas. The image signals from background image areas, regardless of whether they are analyte background image areas or analyte-free background image areas, are also called background signals. Signal series with background signals from background image areas can also be included in the annotated data set for training purposes.

According to one alternative, the analyte-free background image areas can be excluded from the analysis from the outset on the basis of semantics, for example by means of a semantic segmentation of the images. Accordingly, an annotated data set can also be embodied in such a way that signal series from background image areas are just signal series with image signals from the analyte background image areas.

Preferably, the processing model is a classification model, and the result output is a result class of the signal series. Alternatively, the result output is a probability distribution, which always indicates the probability of belonging to one of the result classes, and the objective function detects a difference between the result output and the target output.

Due to the fact that the processing model is implemented as a classification model, an output of the processing model can be easily assigned to the respective result class, and no further matching is necessary. If the classification model is implemented in such a way that it outputs a probability distribution, the result can also be used to determine specifically how certain the processing model is when assigning the result class, which enables the user to check the corresponding assignment if necessary in the event of a doubtful assignment, which is particularly desirable.

Preferably, an objective function is optimized in a plurality of rounds, wherein, in some of the rounds, the sequence of the colored and uncolored signals of one of the input signal series is changed in such a way that the changed sequence corresponds to a sequence of one other of the analyte types to be identified, and the target output corresponding to the changed sequence is used to optimize the objective function.

By appropriately changing the sequence of the colored and uncolored signals of one of the input signal series to obtain a sequence of a different one of the analyte types to be identified, a signal series can be designed, which is used to train in such a way that it trains the model to identify an analyte type for which no signal series is available for training.

Preferably, the objective function is a classification loss and the result output has a value between 0 and 1 for each entry, indicating a probability that the respective signal series belongs to the respective result class.

The classification loss can, for example, be a cross entropy loss, a hinge loss, a logistic loss, or a Kullback-Leibler loss.

By using a classification loss during the training, a probability output can be generated in a particularly simple way.

Preferably, the target output is a target bit series, with the target output comprising a true bit for each colored signal in the signal series and a false bit for each uncolored signal.

Due to the fact that the target output is a target bit series, a result output of the processing model can be matched particularly easily. Furthermore, the target bit series only require little memory, so that the annotated data set can be made available in such a way that it uses as little memory as possible.

Preferably, the result output is a probability distribution in which each image signal of the signal series is assigned a probability as to whether or not the image signal is a colored signal. The objective function detects a difference between the result output and the target output.

Since the result output is a probability distribution, a user checking the output results can easily determine whether the processing model has detected the respective colored signals with a high degree of certainty. Thus, the method allows for a particularly easy interpretation of the output results.

Preferably, the entries of the result outputs are each a value between 0 and 1, indicating a probability that the respective image signal of the signal series is a colored signal.

The objective function can, for example, be an L1 norm, an L2 norm, a cross entropy loss, a hinge loss, a logistic loss, or a Kullback-Leibler loss.

Preferably, the processing model is a fully convolutional network trained as a classification model with fully connected layers by means of signal series from individual image areas, wherein after the training, the classification model is transformed, through replacement of the fully connected layers with convolutional layers, into the fully convolutional network. The fully convolutional network processes the signal series of all image areas from the image series simultaneously. According to one alternative, the fully convolutional network can be trained directly as such.

By training the fully convolutional network as a classification model with fully connected layers, it is possible to save computational power during the training by using signal series of individual image areas, since the entire image series does not always have to be inferred.

Preferably, the calculation of the objective function comprises the calculation a candidate group of candidate objective functions for each analyte signal series. For each of the candidate objective functions, another signal of the colored signals in the signal series is not taken into account when calculating the candidate objective function, for example, by setting it to zero or replacing it with an uncolored signal. When calculating the candidate objective function for signal series of a background image area, one or more colored signals contained in input signal series of background image areas are not taken into account when calculating the candidate objective functions by not including the corresponding colored signals in the calculation or replacing them with uncolored signals. After a group of candidates has been calculated, an objective function of choice is selected from the group of candidates. The objective function of choice is the candidate objective function that has either a second largest or a third largest or a fourth largest difference between the target bit series and the result bit series, preferably a second largest difference.

According to the present method, the target bit series are selected before the image series is acquired in such a way that the various analyte types to be identified have a certain Hamming distance. The Hamming distance in this case is selected in such a way that the analyte type to be identified can still be detected even with an error of one bit, for example. By determining the objective function of choice as described here, the processing model can thus be taught to reliably recognize even incorrectly captured signal series.

Preferably, the processing model is an embedding model that determines an embedding in an embedding space for embedding inputs. The embedding inputs comprise the signal series and the target outputs. The result outputs comprise the embeddings of the signal series. Target embeddings comprise the embeddings of the target outputs. Optimizing the objective function minimizes the difference between the embeddings of embedding inputs of the same result class while maximizing the difference between the embeddings of the embedding inputs of different result classes.

By choosing the objective function in such a way that the target bit series of an analyte type and the corresponding signal series are embedded in the embedding space in such a way that their difference is minimized, it is easily possible to assign the target bit series to the captured signal series. In addition, a matching of the target bit series with the captured signal series is performed directly in the model, which significantly increases the processing speed, since the method can be executed directly on, for example, the graphics card or a special acceleration card for machine learning, such as a tensor processor or an application-specific chip.

Preferably, the target bit series and the signal series are input to the embedding model in different processing paths of an input layer.

By inputting the target bit series and the signal series into different processing paths of an input layer of the embedding model, the embedding model comprises different model parameters for the target bit series and the signal series, which is why they can be appropriately embedded in the embedding space. Therefore, by using different processing paths, a distance in the embedding space is reduced and it is easier to distinguish the analyte types from each other.

Preferably, the optimization of an objective function comprises a plurality of rounds, with a randomization of the signal series being performed in some of the rounds. The randomization comprises: Swapping a sequence of the image signals of the signal series, as well as correspondingly swapping the corresponding entries of the target output and a random selection of a first number of colored signals and a second number of uncolored signals from the set of signal series and the creation of the corresponding target output.

According to the prior art, before an experiment relating to the spatial determination of analytes, target bit series are defined that can be used to identify different analyte types. Depending on the analyte type comprised in the respective samples, different sets of target bit series are used. By randomizing the signal series, the processing model can be trained to recognize analyte signal series independently of the target bit series newly defined for each new experiment. Thus, a model can be trained to recognize signal series from analytes and then applied to completely different sets of target bit series.

Preferably, an objective function is optimized in a plurality of rounds, with an augmentation of the input signal series occurring in some of the rounds. The augmentation may include, for example, one or more of the following: replacing at least a single one of the colored signals of the signal series with an uncolored signal, with the uncolored signal being generated either by lowering the colored signal or by replacing the colored signal with an image signal from the vicinity of the image area of the signal series, from another round of coloring, or from another location in the sample; randomly adding noise to some of the image signals of the image series, for example, the image signals of an signal series, of one of the images of the image series or of all images of the image series; shifting and/or rotating the images of the image series with respect to each other, for example by <2 pixels or ≤1 pixel, for example 0.5 pixels; replacing a single one of the uncolored signals of the signal series with a colored signal; shifting the image signals of at least one of the images of the image series by a constant value; or shifting the image signals of the signal series by a constant value.

The augmentation of the signal series can make a training of the processing model more robust.

Preferably, the signal series are transformed into transformed signal series by means of a transformation and the transformed signal series are input into the processing model. Potential transformations may be one or more of the following: a main component analysis, a main axis transformation, a singular value decomposition, and/or a normalization, with the normalization comprising a normalization of the image signals via an image or a normalization of the image signals via a signal series, or both.

By inputting transformed signal series into the processing model, for example, certain background components that are extracted by means of the main axis transformation or singular value decomposition can be easily assigned or detected in the processing model, which significantly improves the training of the processing model.

Preferably, for example, only a subset of the components of the transformed signal series is input into the processing model.

It turns out that, when performing a suitable transformation, for example with regard to the main component analysis, a first component in the transformed data produces a very large variance but does not contribute to the separation of the analytes. This first component can also be interpreted as the brightness; based on this component, either the other components can be normalized, or the first component can be left out directly. By leaving out the first main component, a background correction is not necessary, which saves time in the further analysis.

Preferably, the annotated data set is generated with at least one of the following: simulating signals of the various markers using a representative background image and a known point spread function of the microscope; generating the annotated data set using a generative model trained on comparable data; acquiring reference images comprising at least one background image and, for each of the background images, at least one image for each of the analyte types, in which analytes of the respective analyte type are marked; performing a classical method for the spatial identification of analytes; acquiring a representative background image and subtracting the image signals of the representative background image pixel by pixel from the image signals of the image series on which the annotated data set is based, prior to providing the annotated data set, so that the annotated data set comprises only background-corrected signal series.

For example, the generative model used may be one of the following models: an active appearance model (AAMs), a generative adversarial network (GANs), a variational autoencoder (VAEs), an auto-regressive model, or a diffusion model.

By acquiring a representative background image of a sample for which the analytes comprised therein are to be spatially determined in the further course, as well as by simulating signals of the markers using the representative background image, as well as a known point spread function of the microscope, an annotated data set can be created in a simple manner and with sufficient accuracy, so that a suitable annotated data set corresponding to the sample with which a suitable processing model can be trained is made available.

Due to the fact that generative models are particularly well suited for artificially creating images, the generation of an annotated data set with a generative model in a particularly efficient manner results in a high-quality annotated data set.

By acquiring reference images with a background image as well as at least one image for each background in which each analyte to be identified is marked, an annotated data set can be created for a respective background image accordingly, because all analytes to be identified are marked via the images and can thus be easily distinguished from the background image.

By carrying out a classical method for the spatial recognition of analytes prior to the creation of the annotated data set, a particularly realistic annotated data set can be created; the creation of the annotated data set in this case is in fact very computationally intensive because the classical evaluation methods are very computationally intensive; but since in this case, each of the target series determined by means of the classical method contains images from a result feature space, a matching is nevertheless particularly reliable here.

By subtracting the image signals of a representative background image from the image signals of the image series, the processing model can disregard the different backgrounds in the different image areas and only needs to be trained according to the signal series that occur. Therefore, the processing model should be able to be trained faster by first subtracting the representative background image.

Preferably, the training of the processing model is a completely new learning of the processing model or a transfer learning of a pre-trained processing model. The pre-trained processing model can, for example, be selected from a set of pre-trained processing models on the basis of contextual information.

By making the processing model a pre-trained processing model, the total time spent on training can be significantly reduced. At the same time, this trains extremely specific processing models in the assignment of result classes with a high degree of accuracy.

Another aspect of the invention relates to a method for training a machine learning system with a candidate extraction model for extracting candidate signal series from an image series. The image series was generated by marking analytes with markers in a plurality of coloring rounds and detecting the markers with a camera. The camera acquires an image of the image series in each coloring round. The markers are selected such that image signals from an analyte in an image area across the image series comprise colored signals and uncolored signals. The method comprises the following steps: Providing an annotated data set. Optimizing an objective function by adjusting the model parameters of the candidate extraction model, wherein the objective function detects a difference between a result output from the candidate extraction model and a target output. The annotated data set comprises at least one signal series of an image area in which image signals from an analyte are captured and one signal series of an image area in which image signals from a background are captured. Furthermore, for each signal series, the annotated data set comprises a target output indicating whether or not the signal series captures image signals from an analyte.

According to the present invention, signal series used as input into the model during the training of a model and/or network for the purpose of training the network have been either acquired in an experiment, simulated, or generated in some other way.

By training a candidate extraction model with signal series from a background area as well as signal series from analytes, a candidate extraction model can be trained to efficiently and quickly detect candidate signal series in signal series that have been extracted from the image series. Accordingly, the use of the candidate extraction model speeds up an analysis of the image series data, since the very computationally intensive matching with the codebook to determine an analyte type of the signal series of the image series only needs to be carried out for the candidate signal series. In addition, the candidate extraction model can also be used to detect candidate signal series that do not, as is customary in the prior art, comprise colored signals that are particularly bright.

According to the present invention, a codebook for each analyte type comprises a sequence of markers that couple to the respective analyte type in the respective coloring rounds.

Preferably, the candidate extraction model is trained to identify candidate signal series on the basis of a number of colored signals, wherein the colored and uncolored signals are identified based on at least one particular ratio of one of the colored and/or uncolored signals of the respective signal series to at least one other of the colored and/or uncolored signals of the respective signal series and/or to identify the candidate signal series, respectively, based on a characteristic signature comprising the at least one particular ratio.

The inventors have realized that the signal series of image areas in which the image signals of analytes are captured each have at least one particular ratio between colored and/or uncolored signals of the respective signal series, which means that a characteristic signature with the at least one particular ratio of the colored and/or uncolored signals is obtained for the candidate signal series. Based on the particular ratio, colored and uncolored signals in a signal series can be identified and thus a number of colored signals in a signal series can be determined. Based on the particular ratio or based on the characteristic signature, a candidate extraction model can be trained to identify the colored and uncolored signals as well as the candidate signal series in the signal series of an image series. By first filtering out the signal series of a candidate area from all signal series before matching the respective signal series with corresponding target series in order to determine an analyte type of the respective analyte or the respective candidate area, the computational effort required to determine an analyte type of a candidate area can be significantly reduced because considerably fewer signal series have to be matched to a codebook.

Preferably, the candidate extraction model is a fully convolutional network that has been trained as a classification model with fully connected layers with signal series of individual image areas. After the training, the fully connected layers of the classification model are transformed into the fully convolutional network by means of convolutional layers; the fully convolutional network can process the signal series of all image area of the image series simultaneously.

By using a classification model with fully connected layers to train the candidate extraction model, the required computational capacity is significantly reduced, which in turn accelerates the training considerably so that the optimized model parameters of the classification model can then be used in the fully convolutional network. In the inference, a fully convolutional network can then be used, which in turn increases a throughput of the network.

According to another alternative, the candidate extraction model can also be trained directly as a fully convolutional network.

Preferably, the candidate extraction model is a semantic segmentation model and the annotated data set comprises, for each image of the image series, a segmentation mask that assigns to each image area a value indicating whether or not the image area is a candidate image area that captures a candidate signal series across the image series, with the value being, for example, a bit indicating whether or not the image area is a candidate area.

By training the candidate extraction model as a semantic segmentation model, it is possible, based on a class of the respective image area assigned according to the semantic segmentation model, to match the signal series only against the codebook in an identification of an analyte type of the candidate area corresponding to a class following the identification of the candidate areas.

Preferably, the segmentation mask comprises more than two classes. For example, a class in which candidate signal series are not searched for in the first place, a class that assigns the image areas to the background, and a class with image areas in which candidate signal series have been found.

The fact that the segmentation mask comprises more than two classes means, for example, that image areas outside cells can be recognized directly by the model, in which case no search for candidate signal series is carried out in these image areas at all, thus further accelerates the process and saves computing power.

Preferably, the candidate extraction model is an image-to-image model and a processing map learned from the candidate extraction model is an image-to-image map. The target output in the annotated data set is either a distance value indicating how far the image area corresponding to each signal series is from a closest candidate area, or a probability value indicating the likelihood that a candidate signal series was captured in the image area.

Due to the fact that the candidate extraction model is an image-to-image model, a threshold can be easily set in the identification or the assignment of the signal series to be used for matching the signal series with the target series of a codebook based on the target output, so that, for example, signal series with the smallest possible distance value or the highest possible probability value are first selected in the inference of the model and successively inferred with an increasing distance value or a decreasing probability value until a number of analytes found corresponds to an expected number of analytes found.

Preferably, the candidate extraction model is implemented as a detection model that outputs a list of candidate areas.

Due to the fact that the candidate extraction model is implemented as a detection model, the output of the candidate extraction model comprises only a very small amount of data, especially at a low population, which is why very little memory is used for storing the data.

Preferably, the annotated data set is generated with at least one of the following: simulating signals of the various markers using a representative background image and a known point spread function of the microscope, generating the annotated data set by means of a generative model trained on comparable data, acquiring reference images comprising at least one background image and, for each of the background images, at least one image in which each of the analytes to be identified is marked, or performing a classical method for spatial analyte recognition.

For example, the generative model used may be one of the following models: an active appearance model (AAMs), a generative adversarial network (GANs), a variational autoencoder (VAEs), an auto-regressive model, or a diffusion model.

By acquiring a representative background image of a sample for which the analytes comprised therein are to be spatially determined in the further course, as well as by simulating signals of the markers using the representative background image, as well as a known point spread function of the microscope, an annotated data set can be created in a simple manner and with sufficient accuracy, so that a suitable annotated data set corresponding to the sample with which a suitable candidate extraction model can be trained is made available.

Due to the fact that the generative model is particularly well suited for artificially creating images, the generation of an annotated data set with a generative model in a particularly efficient manner makes it possible to achieve a high-quality annotated data set.

By acquiring reference images comprising a background image and, for each background, at least one image in which each analyte to be identified is marked, an annotated data set can be correspondingly created for a respective background image since in the at least one other image, all of the analytes to be identified are marked and can thus be easily distinguished from the background image.

By carrying out a classical method for the spatial recognition of analytes prior to the creation of the annotated data set, a particularly realistic annotated data set can be created; the creation of the annotated data set in this case is in fact very computationally intensive because the classical evaluation methods are very computationally intensive. Since in this case, each of the target series determined by means of the classical method contains images from a result feature space, a matching is nevertheless particularly reliable here.

Preferably, the annotated data set is generated by using the previously described method for assigning a result class.

Because the previously described method for assigning a result class by means of the processing model assigns analytes in an image series to an analyte type in a particularly reliable manner, a very reliable annotated data set can be created.

Preferably, the method further comprises swapping a sequence of entries from the signal series of image areas in which the image signals of an analyte are captured before they are input into the candidate extraction model.

Because a sequence of entries from the signal series of image areas capturing image signals from an analyte is swapped during the training, the candidate extraction model can be trained independently of a codebook established prior to the experiment or independently of a sequence of coloring rounds established immediately prior to the experiment, and the candidate extraction model learns only to identify the particular ratios or characteristic signatures on the basis of the particular ratios and thus independently of the sequence of the image signals in the signal series.

Preferably, the optimization of the objective function comprises a plurality of training rounds. A training round is comprised of selecting training data from the annotated data set, determining the objective function based on the training data, identifying signal series from a background area within a first predetermined radius around a candidate area classified as false in a candidate area, and using the identified false-assigned signal series as training data in a next training round, in addition to the training data selected in the next training round.

The inventors have noticed that there is frequent misidentification of the signal series as candidate signal series because there is only a small amount of training data from an immediate vicinity around an image area containing an analyte. Therefore, they propose to specifically train signal series from a background area within the first predetermined radius around the image areas capturing image signals of an analyte more frequently so as to also train the model to correctly identify the signal series from a background area around the image areas containing analytes.

Preferably, the signal series misclassified as being in a candidate area are located outside a predetermined second radius around the candidate area, wherein the predetermined second radius is smaller than the predetermined first radius.

By considering signal series from a distance larger than the predetermined second radius and not considering signal series from image areas within the predetermined second radius, it is possible to achieve a blurring of the class boundaries between true and false positive candidate signal series since the signals from markers always extend across a plurality of pixels due to the point spread function of the microscope.

Preferably, training a machine learning system with a candidate extraction model comprises a completely new learning of the candidate extraction model, or transfer learning from a pre-trained candidate extraction model, wherein the pre-trained candidate extraction model is selected from a set of pre-trained candidate extraction models based on, for example, a sample type, an experiment type, or a user ID.

Because the candidate extraction model is a pre-trained candidate extraction model, the total time spent on training can be significantly reduced, and at the same time, this approach results in a training of highly specific candidate extraction models with a high accuracy in the recognition of candidate areas.

Preferably, the signal series included in the annotated data set are transformed signal series that were generated from signal series using a principal axis transformation or singular value decomposition, wherein the transformed signal series are input into the candidate extraction model for training purposes.

By inputting transformed signal series into the candidate extraction model, for example, certain background components that can be easily eliminated from the transformed signal series by using the main axis transformation or singular value decomposition can already be virtually eliminated by the transformation before they are input into the model, making it easier for the model to detect colored and uncolored signals or candidate signal series.

Another aspect of the invention relates to a method for training a machine learning system with an assignment model, wherein the assignment model comprises a processing model and a candidate extraction model. The processing model is preferably trained by using the method described above for training a machine learning system with an assignment model for assigning result classes. The candidate extraction model has preferably been trained by using the above-described method for training a machine learning system with a candidate extraction model.

Preferably, the processing model and the candidate extraction model in the assignment model comprise a common input layer and the assignment model is preferably trained with candidate signal series as part of the training.

Another aspect of the invention relates to a method for assigning image areas of an image series to result classes by means of a processing model. The processing model was trained to assign image areas from the image series to a result class. The image series is generated by marking analytes with markers in a plurality of coloring rounds and detecting the markers with a camera. The camera acquires an image of the image series in each coloring round, and the markers are selected in such a way that the signal series of analytes in an image area across the image series include colored signals and uncolored signals. The colored and uncolored signals of the analyte signal series have at least one particular ratio of one of the colored and/or uncolored signals of the respective signal series to at least one other of the colored and/or uncolored signals of the respective signal series; alternatively or supplementarily, the analyte signal series have a characteristic signature with the at least one particular ratio. The result classes comprise at least one class for each analyte type to be identified and signal series from analytes for each analyte type to be identified and the signal series of analytes for each analyte type to be identified, each have a specific sequence of the colored and uncolored signals, so that the analyte type can be assigned the respective analyte signal series on the basis of the respective specific sequence. The method comprises the following steps: extracting a plurality of signal series from a respective image area of the image series, inputting the signal series into the processing model, outputting result outputs, and assigning the result classes based on the result outputs.

According to the prior art, pixels are identified in an image series that have an image signal above a certain threshold value. The threshold value is determined locally within each image of the image series. The inventors have realized that, apart from the analytes in an image series which provide particularly bright image signals, there are other analytes whose image signal differs only insignificantly from image signals in an immediate vicinity of the pixels. The signal series each have the characteristic ratio or characteristic signature; moreover, a processing model can be trained to identify, on the basis of the characteristic ratio or characteristic signature, the specific sequence of the colored and uncolored signals; these can be used to assign an analyte type or a result class. Thus, the present method allows for a fast and reliable recognition and assignment of analyte types and result classes.

Preferably, the processing model has been trained to either output a result class of the signal series as the result output or to output a probability distribution across the result classes as the result output, each indicating the probability of belonging to one of the result classes, wherein the result classes comprise, for example, the different analyte types to be identified as well as the background classes.

By having the processing model in the inference directly output an identified result class or a probability distribution across the identified result classes, the entire assignment of a result class can be executed on a graphics card or a special accelerator card for machine learning, such as a tensor processor or an application-specific chip, and can be implemented in a particularly efficient manner.

Preferably, the processing model is a segmentation model, a classification model, or an image-to-image model, wherein the result output of the classification model outputs one of the result classes for each respective input image area, the segmentation model outputs a segmentation mask in which a result class is assigned to each of the image areas of the image series, and the image-to-image model outputs a probability distribution across the result classes or a distance value to each of the result classes for each image area.

Because the processing model is an image-to-image model, a threshold can be easily set when assigning the result class, so that either only one most probable result class is output at a time or the second or third most probable result classes are output as well, which is why a user can see directly from the output how reliably or with what confidence the processing model has assigned the result class.

Preferably, the processing model is a classification model trained to output an output bit series as the result output, wherein the processing model assigns a true value in the bit series to the colored signals of the signal series and assigns a false value in the bit series to the uncolored signals.

By using a classification model, for example a convolutional neural network, result bit series can be generated in a particularly simple manner; these can be matched with the target bit series directly at the output of the classification model.

Preferably, the processing model has been trained to assign a probability to each image signal of an input signal series, which indicates whether the image signal is a colored signal.

Preferably, the assignment of the result classes comprises a multiplication of the result output by an analyte matrix or a determination of a smallest distance. The analyte matrix comprises target bit series of the result classes, so that a result of the multiplication outputs a value for each target bit series, and a result class corresponding to a highest value is assigned to the respective signal series as a result class. Alternatively, the determination of a smallest distance comprises a calculation of the distances between the result output and the target bit series corresponding to the various result classes and after the determination of a smallest distance, the result class of the target bit series with the smallest distance is assigned to a respective signal series as a result class.

The specified distance can be both a distance determined according to an L1 standard and one determined according to an L2 standard. The distance can also be both a simple and a square distance.

By implementing a matching by means of a simple matrix multiplication, the matching can be performed in a particularly simple manner.

An assignment can be made in particularly easy and clear manner on the basis of the distance.

Preferably, the processing model comprises, in an output layer, a convolution layer into which the result output is input, wherein the convolution layer implements the multiplication of the analyte matrix with the result output.

Due to the fact that the multiplication with the analyte matrix is also implemented in the network, the result can be calculated particularly efficiently, for example, on a graphics card or a special acceleration card for machine learning, such as/for example a tensor processor or an application-specific chip.

Furthermore, the matching is implemented only by means of a matrix multiplication in the last convolutional layer, so when a new experiment is performed with a new codebook for matching purposes, the previous analyte matrix can simply be replaced with a new, different analyte matrix based on the new codebook without having to retrain the processing model. If the processing model has been nonspecifically trained to recognize colored and uncolored signals, an analyte-agnostic model has thus been trained that can be easily switched to new analyte matrices and thus to new specific sequences or new analyte-specific samples.

Preferably, the processing model is an embedding model. The embedding model computes embeddings from embedding inputs, wherein the embedding inputs comprise the signal series and the target bit series. The result output is a result embedding and the target bit series embedding is a target embedding. The embedding model is trained to map signal series onto the embedding space such that a difference between the embeddings of the embedding inputs of the same result class is minimized and a difference between the embeddings of the embedding inputs of different result classes is maximized. The result class for a signal series is assigned on the basis of the result embedding and the target embeddings of the different result classes.

Since the processing model is an embedding model, the model can be trained in a particularly elegant manner to embed signal series from analytes as well as their corresponding target bit series in the embedding space in such a way that their distance to each other is minimal, while a distance to all embeddings of other result classes is maximized. If a unique result class assignment is possible, it should also be unique in the embedding space and have a sufficiently large distance from the embeddings of the other result classes.

Preferably, the target bit series and the signal series are input into the embedding model in/on different processing paths of an input layer.

By inputting the target bit series and the input signal series into different processing paths of an input layer of the embedding model, the embedding model comprises different model parameters for the target bit series and the input signal series, which is why they can be embedded appropriately in the embedding space. Therefore, by using different processing paths, a/the distance in the embedding space decreases and the analyte types can be better distinguished from each other.

Preferably, the assignment of the result class comprises a multiplication of the result output by a target embedding matrix or a determination of a smallest distance. The target embedding matrix comprises the embeddings of the target bit series of the result classes, such that a result of the multiplication outputs a value for each result class and the result class with the highest value is a most likely result class. The determination of a smallest distance includes a calculation of the distances between the result embedding and the target embeddings, and a result class corresponding to the target embedding with the smallest distance is assigned to the respective signal series as a result class.

Both the calculation of a distance in an embedding space and a matrix multiplication are simple arithmetic operations that can be used to easily implement a matching, i.e., an assignment of a result class to a signal series, during the inference.

Preferably, the output layer of the processing model is a convolution layer into which the result output is input, wherein the convolution layer implements the multiplication of the result output with the target embedding matrix.

Due to the fact that the multiplication with the analyte matrix is also implemented within the model, the result can be calculated particularly efficiently, for example, on a graphics card or a special acceleration card for machine learning, e.g., a tensor processor or an application-specific chip. Moreover, the matching is implemented only by means of a matrix multiplication in the last convolutional layer; consequently, it is easy to replace the matching with another analyte matrix without having to retrain the processing model. If the processing model has been nonspecifically trained to recognize colored and uncolored signals, an analyte-agnostic model has thus been trained that can be easily switched to new analyte matrices and thus to new specific sequences or new analyte-specific samples. For this purpose, only the new target bit series have to be embedded once by the embedding model to generate the target embedding matrix.

Preferably, a probability of whether the signal series corresponds to the respective result class is output for each result class independently of the distance.

Based on the output probability, a user can easily see how confidently the model has determined the result class, for example by comparing a highest probability and a second highest probability. Thus, the present method allows for a simple determination of a confidence of the model's predictions.

Preferably, the extraction further comprises the following steps: filtering out candidate signal series from the extracted signal series, wherein a ratio of at least one of the colored and/or uncolored signals of a candidate signal series to at least one other of the colored and/or uncolored signals of the respective signal series is a characteristic ratio and/or a candidate signal series comprises a characteristic signature with the at least one characteristic ratio, such that if the signal series comprises at least one characteristic ratio and/or the characteristic signature, the signal series is considered a candidate signal series.

According to the prior art, pixels are identified in an image series that have an image signal above a certain threshold value. The threshold value is determined locally within each image of the image series. The inventors have realized that, apart from the analytes in an image series which provide particularly bright image signals, there are other analytes whose image signal differs only insignificantly from image signals in an immediate vicinity of the pixels. Such candidate signal series can be identified on the basis of the particular ratio of colored and/or uncolored signals to each other or on the basis of a characteristic signature within a signal series comprising at least one particular ratio. Since the candidate extraction model has been trained to recognize candidate signal series as well as the colored and uncolored signals within a signal series on the basis of the particular ratio or to identify them on the basis of a characteristic signature with the at least one particular ratio, it is also possible by means of the present method to find analytes within a sample which, despite being marked with markers, differ only slightly in at least some of the coloring rounds from a brightness of the other signals of the signal series and a brightness of the surrounding pixels.

Preferably, the candidate signal series filtering is performed with a candidate extraction model, wherein the candidate extraction model is selected from a set of candidate extraction models based on, for example, a sample type, an experiment type, or a user ID.

By using a machine-learnable candidate extraction model to identify candidate signal series or to identify analyte areas, it is possible to identify analyte areas or candidate signal series in the image series in a particularly efficient manner.

Preferably, the candidate extraction model has been trained to identify the colored and uncolored signals based on at least one particular ratio of one of the colored and/or uncolored signals of the respective signal series to at least one other of the colored and/or uncolored signals of the respective signal series and/or to identify the candidate signal series, respectively, based on a characteristic signature with the at least one particular ratio.

The inventors have realized that the signal series of image areas in which the image signals of analytes are captured each have at least one particular ratio between colored and/or uncolored signals of the respective signal series, which means that a characteristic signature with the at least one particular ratio of the colored and/or uncolored signals is obtained for the candidate signal series. Based on the particular ratio, colored and uncolored signals in a signal series can be identified and thus a number of colored signals in a signal series can be determined. Based on the particular ratio or based on the characteristic signature, a candidate extraction model can be trained to identify the colored and uncolored signals as well as the candidate signal series in signal series of an image series, i.e., the candidate extraction model learns to recognize certain patterns in the image signals of the signal series. By first filtering out the signal series of a candidate area from all signal series before matching the respective signal series with corresponding target series in order to determine an analyte type of the respective analyte or the respective candidate area, the computational effort required to determine an analyte type of a candidate area can be significantly reduced because considerably fewer signal series have to be matched to a codebook.

Preferably, the candidate extraction model is a semantic segmentation model that outputs a semantic segmentation mask that assigns to each image area a semantic class that indicates whether or not the image area captures image signals from an analyte.

Preferably, the segmentation mask comprises more than two classes. For example, a class in which candidate signal series are not searched for in the first place, a class that assigns the image areas to the background, and a class with image areas in which candidate signal series were found. Alternatively, the segmentation mask may also comprise a plurality of classes in which candidate signal series can be found, each of the plurality of classes comprising, for example, only particular candidate signal series or a particular ratio of different analyte types to each other.

Since the candidate extraction model is a semantic segmentation model, a class of the respective image area assigned according to the semantic segmentation model can be used to match the signal series to the codebook only on the basis of the class in an identification of the result class that follows the identification of the candidate signal series in accordance with the class assigned by the semantic segmentation model, which can save further computing resources during the matching process, since, for example, fewer target bit series have to be matched.

The fact that the segmentation mask comprises more than two classes means, for example, that image areas outside cells can be recognized directly by the model, in which case no search for candidate signal series is carried out in these image areas at all, thus further accelerates the process and saves computing power.

Preferably, the candidate extraction model is a patch classifier that uses a sliding window method to assign the value to each image area.

Preferably, the candidate extraction model is a fully convolutional network and has been trained as a classification model with fully connected layers with signal series of individual image areas, wherein after the training, the classification model is transformed, through replacement of the fully connected layers with convolutional layers, into the fully convolutional network, which processes the signal series of all image areas of the image series simultaneously.

By using a classification model with fully connected layers to train the candidate extraction model, the required computing capacity is significantly reduced during the training, so that the training can be accelerated considerably and so that the optimized model parameters of the classification model can then be used in the fully convolutional network. Due to the fact that a predominant portion of the image areas of the image series do not capture signals from analytes and thus belong to the background image areas, training as a fully convolutional network, into which complete images would always be imported, would result in a very unbalanced training, since a ratio between signal series from background image areas and signal series with image signals from analytes would be dominated by the signal series from background image areas. Therefore, the training as a fully connected network allows the training data to be balanced by an appropriate balanced selection of signal series from background image areas and image areas capturing the signals from analytes, so that the identification of candidate signal series is also sufficiently trained. IA fully convolutional network can then be used in the inference, which in turn increases a throughput of the network.

According to one alternative, the candidate extraction model can also be trained directly as a fully convolutional network.

Preferably, the candidate extraction model is an image-to-image model that performs an image-to-image mapping that assigns to each image area a distance value indicating how far the image area is from the closest image area having a candidate signal series, or that assigns to each pixel a probability of being an image area having a candidate signal series.

Due to the fact that the candidate extraction model is an image-to-image model, a threshold can be easily set in the identification of the signal series to be used for matching the signal series with the target series of a codebook based on the target output, so that, for example, signal series with the smallest possible distance value or the highest possible probability value are first selected in the inference of the model and successively inferred with an increasing distance value or a decreasing probability value until a number of analytes found corresponds to an expected number of analytes found.

Preferably, the candidate extraction model is implemented as a detection model and outputs a list of image areas that capture the image signals of an analyte.

The image coordinates include spatial and temporal components, since the image series has both spatial and temporal coordinates.

Due to the fact that the candidate extraction model is implemented as a detection model, the output of the candidate extraction model comprises very little data, especially in the case of low numbers, and therefore little data is consumed.

Preferably, before checking whether the signal series is a candidate signal series, the method further comprises a step of “transforming the signal series by means of a main axis transformation or a singular value decomposition,” wherein the transformed signal series is used to check whether the signal series is a candidate signal series.

By inputting transformed signal series into the candidate extraction model, for example, certain background components that can be easily eliminated from the transformed signal series by using the main axis transformation or singular value decomposition can already be virtually eliminated by the transformation before they are input into the model, making it easier for the model to detect colored and uncolored signals or candidate signal series.

Preferably, the image areas are either each only one pixel, an area of contiguous pixels, or a contiguous volume in an image stack, wherein the image signals of the image areas are input into the candidate extraction model, for example, as a tensor.

By combining a plurality of pixels into one image area, it is possible to reduce the computing power required during the evaluation of the signal series. On the other hand, a pixel-by-pixel evaluation makes it possible, if necessary, to separate image areas that are close to each other and would merge with each other if the plurality of pixels were combined.

Accordingly, a size of an image area may be selected on the basis of an expected analyte density in the sample. Preferably, the size of an image area can vary across the entire image, depending on the expected analyte density in the image area.

By choosing the size of an image area on the basis of an expected analyte density, it is possible to optimize the required computing power according to an expected analyte density.

When signal series are input into a model, for example the processing model, according to the present invention, either the signal series of individual image areas can be input into the model, also spoken of as the receptive field of the model then comprising only a single image area, or alternatively the receptive field of the model can also comprise signal series from adjacent image areas. In that case, the model processes the signal series of the respective image area on the basis of, among other things, the image signals or the signal series of the other image areas in the receptive field. This is also spoken of as the spatial context being taken into consideration in the processing of the image signals or signal series of the image area, in this case the image signals or the signal series of the adjacent image areas that are part of the receptive field of the model.

A number of image areas in the receptive field may be selected based on, for example, the point spread function of the microscope in such a way that a diameter of the receptive field is not larger than, only slightly larger than, or, for example, twice as large as a diameter of an area onto which a point in a sample is mapped on the basis of the point spread function. For example, the receptive field is 3×3, 5×5, 7×7, 9×9, 13×13, 17×17 image areas in size, but the receptive field may also be 3×3×3, 5×5×5, 7×7×7, 9×9×9, 13×13×13, or even 17×17×17 image areas in size when image stacks are acquired in the coloring rounds.

Preferably, the processing model and the candidate extraction model form a common assignment model with a common input layer.

Preferably, a plurality of the candidate extraction model and processing model layers, comprising the common input layer, form a common input master in which the signal series for the candidate extraction model and the processing model are processed together.

Preferably, the signal series are first processed by the candidate extraction model and the signal series identified as candidate signal series are then processed by the processing model in order to assign a result class to the candidate signal series. Alternatively, the signal series are processed independently of each other in the two models.

Because the extraction of the candidate signal series and the matching of the candidate signal series to the result classes are implemented in a common model with a common input layer, a processing of the signal series can be simplified by the fact/to the effect that only one model, the mapping model, has to be served.

By having the processing model and the candidate extraction model share the common input master, the computations performed in the common input master only need to be carried out once, which provides speed advantages.

Preferably, the outputs of the two models of the assignment model are combined in a final assignment step independently of the assignment model.

Alternatively, the output of the two models is combined in an output layer of the assignment model such that signal series not identified as candidate signal series by the candidate extraction model are automatically assigned to a result class corresponding to the background, and the identified candidate signal series are assigned to a result class corresponding to an analyte type according to the assignment of the processing model.

By combining the outputs of the two models of the assignment model in a final output layer, a possibly time-consuming assignment outside the assignment model can be omitted, which further speeds up the assignment.

Preferably, the method comprises “the determination of an image region.” In this case, the determination of an image region particularly comprises the combining of adjacent image areas into an image region if the adjacent image areas comprise candidate signal series, wherein the combining of adjacent image areas comprises non-maximal suppression, for example.

By grouping image areas into image regions and determining image region signal series, the computational effort for the evaluation of the image series can be significantly reduced.

Preferably, the determination of an image region furthermore comprises verifying the image regions, wherein the verifying of the image regions comprises at least separating the image region into two or more image regions if the image region exceeds a maximum size, separating the image regions into two or more image regions if the image regions are each connected to each other only by a few bridge pixels or a shape of the image region indicates that two image regions overlap here, separating the image region based on the analyte context information and a discarding of the image regions, if an image region falls below a minimum size or has a shape that cannot be reliably assigned to an analyte type.

Preferably, the maximum size of the image region is selected depending on the point spread function of an imaging device.

In addition, the maximum size can also be selected on the basis of an expected analyte density in such a way that the maximum size is as small as possible in the case of a high expected analyte density, while larger maximum sizes are permissible in the case of a low expected analyte density. The maximum size can be chosen according to a semantic segmentation of the image.

By choosing the maximum size based on the point spread function of an acquisition device, the size of an image region can be optimally matched to an expected expansion of a signal from an analyte. Thus, computational resources are not unnecessarily wasted by analyzing too many signal series, and furthermore, an overly coarse rasterization is prevented as well by choosing the maximum size based on the point spread function.

By separating or disregarding image regions on the basis of certain criteria, the computing power that is required can be considerably reduced when checking whether the signal series of the respective image region is a candidate signal series and when identifying an analyte type of the signal series; in addition, the separation makes it possible to avoid capturing a plurality of analyte types, in particular a plurality of different analyte types in an image region if an expected analyte density is very high.

Preferably, the determination of an image region signal series comprises combining image signals of adjacent pixels into a combined image signal of the image region.

Preferably, an image region is determined after the verification that the signal series is a candidate signal series and before the assignment of a result class of the signal series and/or after the assignment of a result class of the signal series.

The fact that the image regions can be determined both before and after the assignment of a result class ensures that, for example, the image regions can still be separated after the assignment of a result class if, for example, so many colored signals are found in an image region that a plurality of candidate signal series may have been captured in the image region. Accordingly, the separation of the image regions allows for an improved identification of a result class and thus a better assignment of an analyte type to a signal series.

Preferably, the method comprises the use of the assigned result class as analyte context information for the determination of the image region, with the analyte context information comprising in particular: information about a size of an analyte region depending on the result class, information about a location of an analyte region in a sample, and information about co-localizations of certain analyte types in certain areas or in a location in a sample, and about the expected analyte densities depending on a location in a sample or of an image area.

Due to the fact that context information about an identified analyte type or result class is used in particular when determining the image region, corrections to the determination can be made or errors in the determination can be corrected even after the analyte type of a signal series has been identified.

It is conceivable, for example, that certain analyte types only occur in certain areas of a sample, for example, in certain areas of a cell; if the identification of an analyte type results in, for example, a first analyte type with a first probability and a second analyte type with a second probability, the context information can be used to determine, for example, that the analyte certainly does not correspond to the first analyte type, even if the probability, i.e., the first probability is higher than the second probability.

Preferably, the determination of an image region comprises a verification of the signal region after the verification that the signal series is a candidate signal series and before the assignment of a result class and/or after the assignment of the result class.

The fact that the signal region is verified after both the verification and the assignment of the analyte type means that, for example, the signal region can still be changed if the analyte determination is ambiguous, in order to potentially improve the determination of the analyte type.

Preferably, the method further comprises generating an extended annotated data set based on the extracted signal series and the assignment of the signal series to a result class, and implementing a method for training a machine learning system according to any of the methods for training a machine learning system described above, wherein the extended annotated data set is used as the annotated data set in the training.

Due to the fact that another method is used after the assignment of a result class, the candidate extraction model can be trained to recognize candidate signal series even better after the assignment of the result class using an improved or extended annotated data set.

Preferably, the method further comprises a step of performing a background correction of the image signals of the image series, wherein performing the background correction comprises one or more of the following: a rolling-ball method, a filtering such as a top-hat method, a homomorphic filtering, a low-pass filtering, wherein the result of the low-pass filtering is subtracted from the signal, or a temporal filtering, a background correction by means of an image-to-image model, a background correction by means of mixed models, a background correction by means of a mean-shift method, a background correction by means of a main component analysis, a background correction by means of a non-negative matrix factorization, or a background correction by means of excitation of the auto-fluorescence with at least one specific laser for all image areas of the image series, wherein the specific laser corresponds exactly to an excitation spectral range of one of the markers used and the analytes are not yet marked with markers, or background correction by means of excitation of the auto-fluorescence by means of a non-specific laser for all image areas of the image series.

Because the method comprises a background correction, the image signals of the signal series can be separated from the background independently and thus in a better manner, or that a computational effort is reduced, for example during the matching, because the background contributions no longer have to be taken into account.

By performing a background correction based on an imaging with a specific laser, where the analytes are not yet marked with markers, the acquired background image should match particularly well with the image background acquired in the coloring rounds, which is why a background correction should be particularly accurate.

Preferably, the extraction of the signal series comprises at least one of the following: extracting all image areas of the image series; extracting a random selection of the image areas from the image series; extracting a selection of the image areas of the image series weighted by a structural property of the image areas, for example, with a higher probability for cells, cell nuclei, and bright pixels; extracting image areas exclusively from image areas with a minimum level of image sharpness; and skipping image areas where no analytes are expected.

By deftly extracting the image areas as described above, the effort associated with the evaluation of the image signals of the image series can be reduced considerably.

Preferably, a method further comprises analyzing a quality of the images of the image series and repeating the acquisition of one of the images of the image series if the quality is not sufficiently high, wherein the quality is determined on the basis of, for example, one or more of the following: the relative signal strength of the images to each other, the pixels present in the individual images having image signals above a certain threshold based on an unexpected distribution of identified analytes, wherein the analytes were disproportionately identified on the basis of a particular one of the images of the image series, a machine-learned quality assessment model, which was trained to determine a quality score for an image, a sub-image, or individual pixels or image areas.

By analyzing the quality of the images directly, a quality of the images can already be determined during an experiment when the images are acquired and an acquisition can be repeated accordingly; this is often no longer possible after an experiment has been completed since the samples are no longer in a desired state. Thus, through the analysis of the quality of the images, the invention achieves an increase in the reliability of the determination of analytes, since poorly acquired images can be repeated immediately.

### BRIEF SUMMARY OF THE FIGURES

The invention is explained in more detail below with reference to the examples shown in the drawings. The drawings show the following:

FIG. 1 schematically illustrates a system for use with the method for identifying analytes in an image series according to one embodiment;

FIG. 2 schematically illustrates a device for use with the method according to one embodiment;

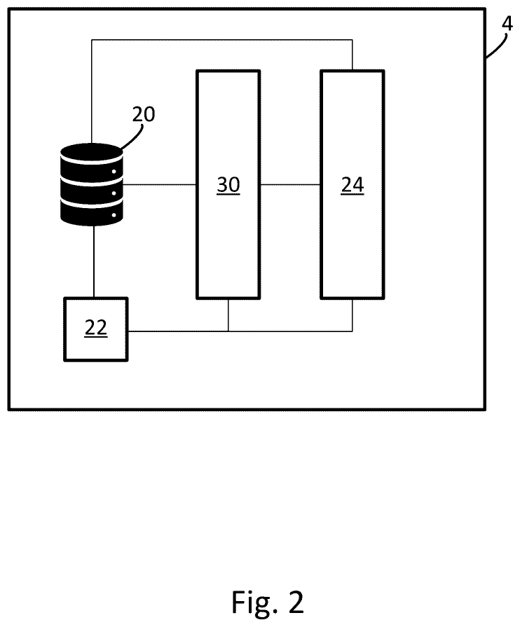

FIG. 3 schematically illustrates a method for generating an image series by marking analytes with markers in a plurality of coloring rounds and detecting the markers with a camera, as is performed before identifying analytes in the image series;

FIG. 4 schematically illustrates a method for training and inferring an analyte data evaluation system;

FIG. 5 schematically illustrates a method for training and inferring an analyte data evaluation system;

FIG. 6 schematically illustrates a method for assigning a result class;

FIG. 7 schematically illustrates a method for assigning a result class;

FIG. 8 schematically illustrates a method for assigning a result class;

FIG. 9 schematically illustrates a processing model that may be used according to a plurality of the embodiments;

FIG. 10 schematically illustrates measurement data of the kind that is analyzed in the various methods of the various embodiments;

FIG. 11 schematically illustrates processes of a method according to a further embodiment;

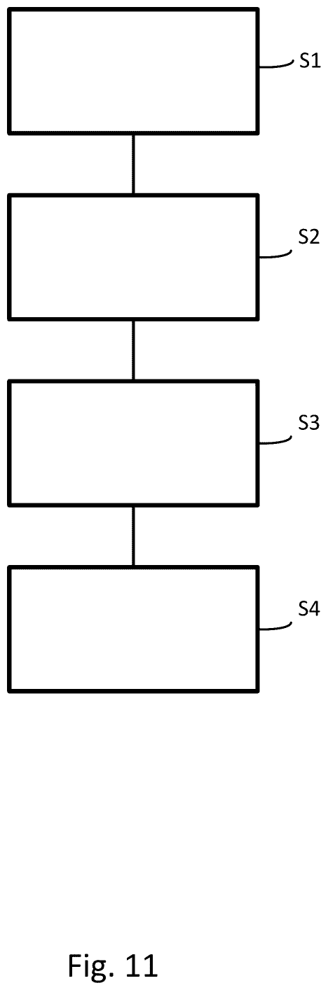

### DETAILED DESCRIPTION OF THE EMBODIMENTS

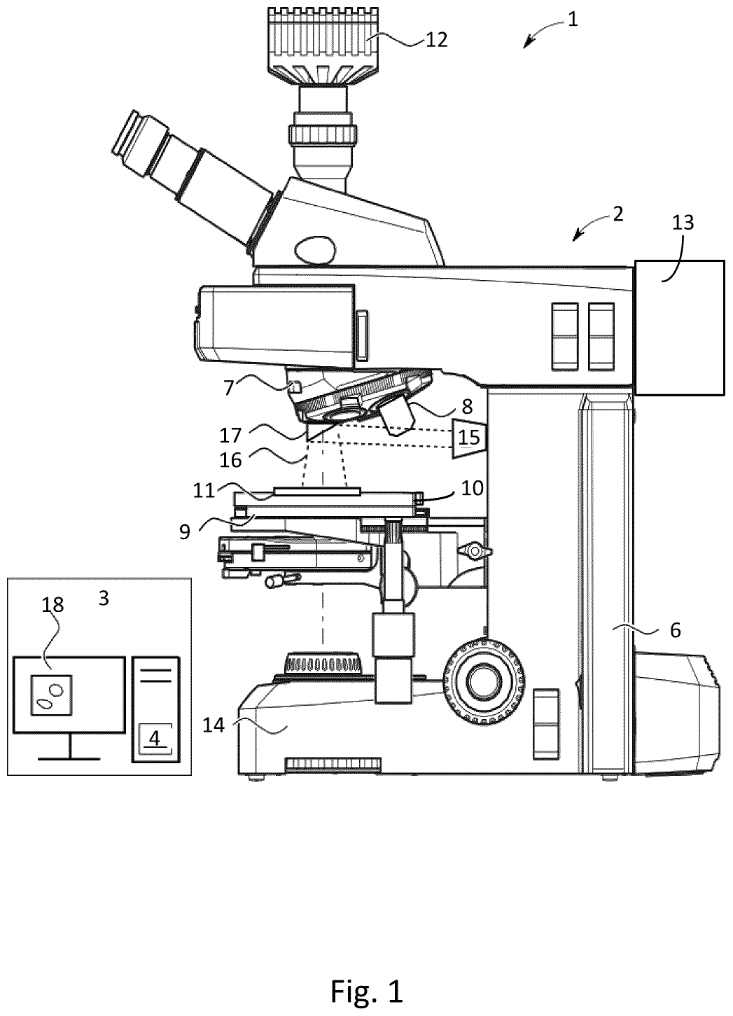

One embodiment of an analyte data evaluation system 1 comprises a microscope 2, a control device 3, and an evaluation device 4. The microscope 2 is communicatively coupled to the evaluation device 4 (for example, with a wired or wireless communication link). The evaluation device 4 can evaluate microscope images 5 captured with the microscope 2 (FIG. 1). If the analyte data evaluation system 1 comprises a processing model, it is also referred to as a machine learning system.

The microscope 2 is a light microscope. The microscope 2 comprises a stand 6 which includes further microscope components. The further microscope components are, in particular, an objective changer or nosepiece 7 with a mounted objective 8, a specimen stage 9 with a holding frame 10 for holding a specimen carrier 11, and a microscope camera 12.

If a specimen is clamped into the specimen carrier 11 and the objective 8 is pivoted into the microscope beam path, a fluorescent illumination device 13 can illuminate the specimen for fluorescence imaging purposes, and the microscope camera 12 receives the fluorescent light as a detection light from the clamped specimen and can acquire a microscope image 5 in a fluorescence contrast. If the microscope 2 is to be used for a transmitted light microscopy, a transmitted light illumination device 14 can be used to illuminate the sample. The microscope camera 12 receives the detection light after it has passed through the clamped sample and acquires a microscope image 5. Samples can be any objects, fluids, or structures.

Optionally, the microscope 2 comprises an overview camera 15 for acquiring overview images of a sample environment. The overview images show, for example, the specimen carrier 11. A field of view 16 of the overview camera 15 is larger than a field of view when the microscope camera 12 acquires a microscope image 5. The overview camera 15 views the specimen carrier 11 by means of a mirror 17. The mirror 17 is arranged on the nosepiece 7 and can be selected instead of the objective 8.

According to this embodiment, the control device 3, as shown schematically in FIG. 1, comprises a screen 18 and the evaluation device 4. The control device 3 is configured to control the microscope 2 for acquiring image series 19 of microscope images 5 and to store the image series 19 acquired by the microscope camera 12 on a memory module 20 of the evaluation device 4 and to display them on the screen 18 as needed. The acquired microscope images 5 are then further processed by the evaluation device 4.

The evaluation device 4 comprises various modules which exchange data via channels 21. The channels 21 are logical data connections between the individual modules. The modules can be software modules or hardware modules.

The evaluation device 4 comprises the memory module 20. The memory module 20 stores the images 5 acquired by the microscope 2 and manages the data to be evaluated in the evaluation device 4.

The evaluation device 4 comprises the memory module 20, by means of which image data from the image series 19 is held and stored. A control module 22 reads the image data from the image series 19 as well as a code book 23 from the memory module 20 and sends the image data and the code book 23 to a processing module 24. According to one embodiment, the control module 22 reads the signal series 31 of each image area of the image series 19 and inputs them into the processing module 24.

According to one embodiment, the processing module 24 comprises a processing model 28, such as a classification model, that can, for example, be implemented as a neural network. The processing module 24 receives the signal series 31 from the control module 22 and outputs a result output 32. The result output 32 allows for an assignment of a result class to each of the input signal series 31.

The control module 32 receives the control module 22 from the processing module 24 and stores it in the memory module 20.

As part of the training of the processing model 28, the control module 22 reads an annotated data set from the memory module 20 and inputs the annotated data set into the processing module 28, for example, by using a stochastic gradient descent method. Based on the result outputs 32 and target outputs contained in the annotated data set, the control module 22 calculates an objective function and optimizes the objective function by adjusting the model parameters of the processing model 28.

Once the processing model 28 is fully trained, the control module 22 stores the determined model parameters in the memory module 20.

In addition to the model parameters, the control module 22 may also store contextual information about the acquired images.

According to this embodiment, the evaluation device 4 comprises a candidate extraction module 27 as well.

The candidate extraction module 27 is designed to extract from the image data of the image series 19 a plurality of signal series 31 of a respective image area of the image series 19 and to filter out candidate signal series from the extracted signal series 31, wherein candidate signal series are signal series 31 of image areas that have a high probability of having captured image signals from analytes 39, i.e., in some of the image areas of the image series 19, the signal series 31 comprise image signals originating from a marker coupled to an analyte 39.

The candidate extraction module 27 is implemented as a neural network called a candidate extraction model that is, for example, trained to detect and output candidate signal series in the extracted signal series.

During the training, the control module 22 exports a portion of the image data of an annotated data set from the memory module 20 and transmits it to the candidate extraction module 27. The control module 22 determines an objective function based on the result outputs of the candidate extraction model and on the target data in the annotated data set, and optimizes the objective function by adjusting the model parameters of the candidate extraction model based on the objective function.

The training is carried out, for example, by using a stochastic gradient descent method. Any other training method may be used as well. Once training is complete, the control module 22 stores the model parameters of the candidate extraction model in the memory module 20.

During the inference, the candidate extraction module 27 outputs the candidate signal series output by the candidate extraction model either to the control module 22, which stores the candidate signal series in the memory module 20 for later analysis, or directly to the processing module 24, which then outputs a result output 32 corresponding to the candidate signal series as described above, which can be used to determine the result class of the signal series 31.

Both the classification model and the candidate extraction model can each be implemented as a neural network, a convolutional neural network (CNN), a multi-layer perceptron (MLP), or as a sequential network, for example a recurrent neural network (RNN) or a transformer network.

If the models are embodied as a sequential network, the signal series 31 are not input into the respective model as a whole, but rather the image signals of the signal series 31 are input into the model individually. If the model is a convolutional network and is implemented as a sequential network, then the model first sees image of a first coloring round, then image of a second coloring round and then step by step the images of the following coloring rounds. In a coloring round N, the model only gets the image from round N input and has an internal state that internally encodes or stores the images from rounds 1 to N−1. In round N, the model then processes the internal state with the image from the coloring round N.

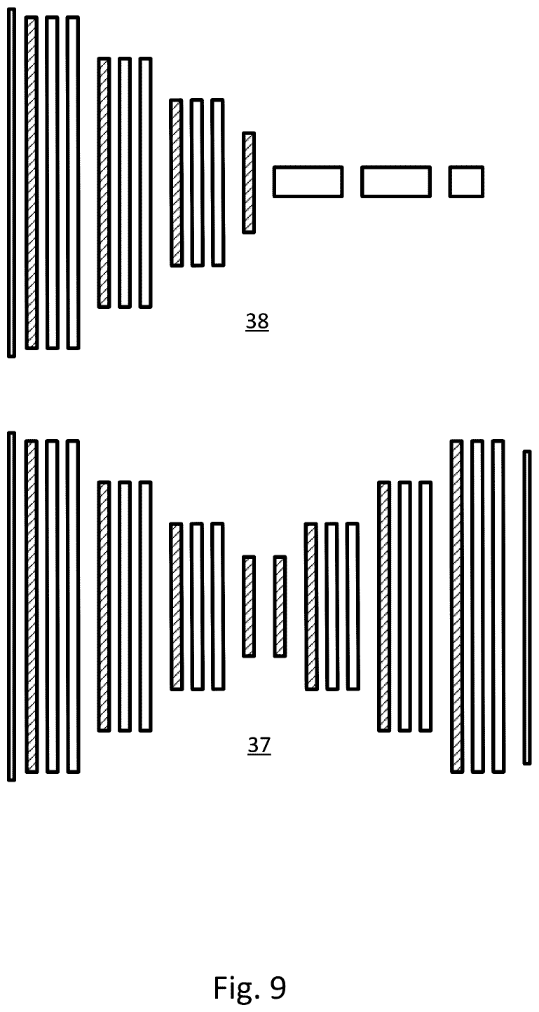

A method of operating the analyte data evaluation system 1 (FIG. 9) is described below.

In the method described for operating the analyte data evaluation system 1, annotated data sets are first generated in a step S1. For this purpose, the microscope camera 12 first acquires an image series 19. To acquire the image series 19, the analytes 39 in a sample are marked in a plurality of coloring rounds such that, for image areas that capture image signals from an analyte 39, a signal series 31 comprising colored signals and uncolored signals is obtained across the image series 19, wherein the markers are selected such that a sequence of colored signals and uncolored signals corresponding to a target bit series 35 of the analyte types in the codebook 23 is obtained for the signal series 31 of a particular analyte type.

In accordance with the present invention, the markers are coupled to analytes 39 and then captured by the microscope camera 12. When coupling the markers to the analytes 39, different analytes 39 may be marked with markers having different fluorescent dyes. For example, if n different fluorescent dyes are used, a number of n images are acquired after coupling. The n images are each acquired with a different fluorescence contrast corresponding to the number n of different fluorescent dyes. Each of these n images corresponds to one coloring round. After the acquisition of the n images, the markers are again decoupled from the analytes 39. A coupling process as well as the acquisition of the n coloring rounds together with the decoupling of the markers is also called a marking round. After the markers have been decoupled from the analytes 39 again, the analytes 39 can be marked again with new markers in a new marking round.

When markers are coupled to analytes 39 again, this time different colored markers can each couple to analytes 39. Some of the analytes 39 to be identified may not be marked with a marker at all in some of the different individual marking rounds. A signal series 31 that is expected for a particular analyte 39 or a particular analyte type is produced by the resulting patterns of colored and uncolored signals or colored and uncolored signals, in each case in relation to a fluorescence color. These signal series to be expected are summarized in the codebook 23 for all analyte types to be identified, with the markers in the respective marking rounds being selected in such a way that just the expected signal series 31 for the respective analyte type is produced.

According to one alternative, only one image can be acquired per marking round by means of fluorescence imaging with a broad fluorescence excitation spectrum that excites the fluorescence of all fluorescent dyes used simultaneously. The acquired image is then converted into the respective n fluorescence contrasts by means of filters after the capture, so that n images are once again available for n coloring rounds of a marking round.

According to this embodiment, the codebook 23 comprises target bit series 35, wherein each expected colored signal is assigned a true value and each expected uncolored signal is assigned a false value.

According to another embodiment, only markers with a single fluorescent dye are used per marking round. For this case, the coloring rounds are exactly equal to the marking rounds.

After the acquisition of the image series 19, images 5 of the image series 19 are registered to each other. The registration can be carried out by means of a classical registration algorithm or by means of a trained registration model.

Even though it is described here by way of example that one image is acquired in each of the coloring rounds, a stack of images 5 can also be acquired in each coloring round, in which case the images 5 of the stack must, on the one hand, be registered to each other, and, on the other hand, the images from different coloring rounds must be registered to each other.

After registering the images 5 of the image series 19 with respect to each other and storing the registered image series 19, the image series 19 may be analyzed by using a classical algorithm for analyzing image series 19 with analytes 39, as described for example in the prior art documents referenced above.

If an image stack is acquired in each coloring round with the acquisition of the image series 19, a signal series 31 may also be extracted for a contiguous volume of pixels in the image stack instead of individual pixels. A signal series 31 according to the present invention always corresponds to an image area. An image area may comprise a single pixel, an area of adjacent pixels, or a volume of adjacent pixels, wherein the image areas in the different images or image stacks of the image series 19 are registered to each other, i.e., the same coordinates in the images show the same objects in the samples.

According to this embodiment, the codebook 23 is present as a collection of target bit series 35.

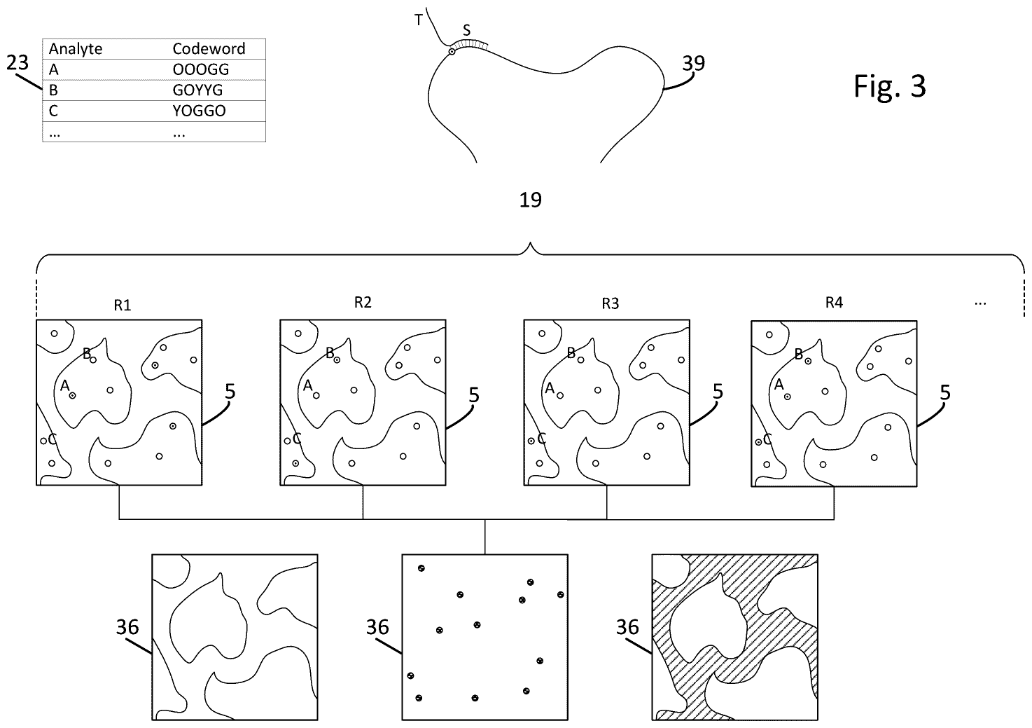

According to one alternative, however, the codebook 23 can also be coded as a color sequence, as shown schematically in FIG. 3, and any other coding is possible as well.

After the image series 19 has been analyzed, the analyzed signal series 31 may be stored in the annotated data set for training the candidate extraction model and also in the annotated data set for training the processing model 28 in the memory module 20 and a training phase may follow the generation of the annotated data set(s). The control module 22 may either store a single annotated data set or a separate annotated data set for each of the models. If only a single annotated data set is stored, the annotated data set comprises the respective signal series 31 and an appropriate annotation for each of the signal series 31 for each of the models.

Along with the signal series 31, for example, the result class may be stored. As part of the training of the candidate extraction model, the control module 22 knows from the result class whether the signal series 31 captures image signals from an analyte 39, or whether the signal series 31 captures image signals from the background, and can correspondingly evaluate a correct or incorrect assignment of the candidate signal series by using the objective function.

The signal series 31 stored in step S1 form the signal series of the annotated data set.

In the example described above, the signal series were acquired in an experiment. According to one alternative, the annotated data set can be generated by means other than the classical multiomics.

The signals of the different markers can, for example, be simulated using a representative background image and a known point spread function of the microscope 2. The codebook 23 is also included in such a simulation.

Alternatively, a generative model can be trained to generate the signal series of the annotated data set. Since generative models are particularly well suited for generating images, a particularly realistic annotated data set can be created by using a generative model.

For example, the generative model used may be one of the following models: an active appearance model (AAMs), a generative adversarial network (GANs), a variational autoencoder (VAEs), an auto-regressive model, or a diffusion model.

The training of the candidate extraction model as well as the processing model 28 is performed in step S2.

According to this embodiment, the candidate extraction model is trained to identify candidate signal series based on a number of colored signals or to identify each of the candidate signal series based on a characteristic signature comprising at least one particular ratio. To distinguish the colored signals from the uncolored signals, the candidate extraction model learns to identify at least one particular ratio of colored signal to uncolored signal, colored signal to colored signal, uncolored signal to colored signal, or uncolored signal to uncolored signal in a candidate signal series. This means that a candidate signal series comprises at least a particular ratio of a colored and/or uncolored signal of the respective signal series 31 to at least one other of the colored and/or uncolored signals of the respective signal series 31.

The particular ratio may be a certain distance or difference between the image signals, a quotient between the image signals, a certain number of image signals with a higher image signal than the others, wherein the ratio may be learned for a normalized image signal or for non-normalized image signals, respectively.

While the prior art mainly considers image signals from very bright pixels during the identification of analytes, the inventors have realized that signal series 31 of pixels that capture image signals of analytes 39 comprise image signals with the particular ratio described above and that the signal series 31 each have the characteristic signature. Analytically, the characteristic signature is difficult to define, as it may be different for different analyte types, but it turns out that neural networks can identify the characteristic signature or the particular ratio very well when adequately trained.

To detect the number of colored signals in a candidate signal series, an annotated data set must comprise signal series from an image area that captures image signals from an analyte 39, wherein colored signals and uncolored signals from the signal series have the particular ratio or characteristic signature. Additionally, the annotated data set may comprise signal series from image areas of the background. The background image areas comprise colored signals only sporadically, which are mostly due to non-removed or incorrectly coupled markers.

According to the first embodiment, the candidate extraction model is a fully convolutional network 37. The candidate extraction model is first trained as a classification model, which is a fully connected network 38 with fully connected layers, by using the signal series 31 of individual image areas stored as signal series in step S1. For this purpose, the candidate extraction control module 29 inputs the signal series 31 of the annotated data set into the candidate extraction model. The classification model assigns a class to the signal series 31 that indicates whether the signal series 31 is a candidate signal series. A candidate signal series is a signal series that either has the characteristic signature or has a high probability of having the characteristic signature, or has the colored signals or uncolored signals with the particular ratio, or has a certain number of the colored signals and/or uncolored signals.

The classification model can either be a binary classifier, in which case a “1” indicates a candidate signal series, but the class assignment can also be soft in that the classification model outputs a probability of belonging to the respective class for each class.

The control module 22, in turn, controls the training by reading a portion of the signal series 31 from the annotated data set, feeds the signal series to the classification model, and, using an objective function, detects a difference between the output of the classification model and a target output. Furthermore, the control module 22 optimizes the objective function based on the model parameters of the classification model.

As described above with regard to the candidate extraction model, the classification model ultimately learns to recognize the particular ratio or characteristic signature as well. In addition, the classification model is trained to also recognize the specific sequence in which colored and uncolored signals occur in the analyte signal series 31 and to assign the respective analyte types to the signal series 31 based on the specific sequence of the different analyte types.

Once the classification model is finished training with the fully connected layers, the fully connected layers are converted to fully convolutional layers. The resulting fully convolutional network 37 can then process a complete image series 31 as input. The completely trained classification model or the network, then transformed into the fully convolutional network 37, for example, emits as its output a segmentation mask 36 in which all image areas with candidate signal series are highlighted (see FIG. 3, bottom center).

According to one alternative, the candidate extraction model may also be an image-to-image model that learns an image-to-image mapping. A target output in the annotated data set is then either a distance value indicating how far away the respective image area is from a closest image area with a candidate signal series, or a probability value indicating how likely the image area is to capture a candidate image series.

According to another alternative, the candidate extraction model is a detection model. The detection model simply outputs a list of image areas that detect a candidate signal series.

In addition, one or more reference images, comprising at least one background image, may be acquired as well, and, for each background image, at least one image in which the analytes 39 to be identified are coupled to a marker and the markers are captured in the respective image areas.

Furthermore, if different fluorescent dyes are used in the different coloring rounds, each analyte should be marked with each of the different fluorescent dyes. Of course, any known classical method such as the method described in the aforementioned patent applications EP 2 992 115 B1, WO 2020/254519 A1, and WO 2021/255244 A1 can be used to generate the annotated data set as well.

According to another alternative, the different candidate extraction models can be trained to also recognize signal series 31 in which the sequence in which the markers are used in the coloring rounds has been swapped by swapping the sequence of the image signals 31 in the training signal series 31 during the training. It is thus possible to train signal series-agnostic models.

Signal series-agnostic training is particularly useful if no signal series have yet been measured for the plurality of analyte types to be identified and thus cannot be included in the annotated data set. In this case, the image signals of the signal series 31 would be swapped for training purposes in such a way that a binarization of the image signals of the swapped signal series 31 results in the target bit series 35 that belongs to an analyte type to be identified and for which no training signal series 31 has been measured, i.e. has not yet been recorded in an experiment.

According to the embodiment, the control module 22 may, after the determination of the objective function, identify signal series 31 that were incorrectly classified as candidate signal series and that originate from an image area that is within a first predetermined radius around an image area that actually captured a candidate signal series. Since the signal series 31 are randomly selected from the annotated data set, only a few signal series 31 used in training may lie within the first predetermined radius. A correct classification of such signal series 31 is difficult for the candidate extraction model due to the small number in the respective training set. To improve a detection of these signal series 31 incorrectly classified as candidate signal series, these signal series incorrectly classified as candidate signal series are automatically included in a data set to be trained in a subsequent training round to increase their weight in the objective function. This procedure is also called hard-negative mining.

According to one modification, the signal series of pixels that are within a second predetermined radius, which is smaller than the first predetermined radius, immediately adjacent to an image area that correctly captures a candidate signal series can optionally not be included in the following training round during hard negative mining. According to the point spread function of microscopes 2, marker signals typically span multiple pixels. If signal series 31 of pixels within the second predetermined radius were now also used for hard-negative mining purposes, this would result in a blurring of the class boundaries, which should be avoided.

When training the candidate extraction model, a pre-trained model can be selected from a set of pre-trained models and the pre-trained model can be adapted to a new experiment by means of transfer learning.

In addition to the training of the candidate extraction model, step S2 further comprises the training of a processing model 28.

According to this embodiment, the processing model 28 is trained as a classification model, also called an assignment model, to identify an analyte type directly. An annotated data set for training the processing model 28 comprises the images 5 of the image series 19 comprising signal series 31 to which result classes have been assigned. For each input signal series 31, the processing model 28 outputs a probability distribution with the respective probabilities of belonging to the various analyte types to be identified. A target output of the assignment model comprises a hard assignment to each of the analyte types.

The annotated data set may further comprise signal series 31 of image areas that capture a background without image signals from analytes. For these training signal series 31 of background image areas, the set of result classes additionally comprises at least one class for these background image areas. If different types of background occur, for example, in different semantic areas of a sample, it may also be appropriate to assign different background classes.

As explained above with regard to the training of the candidate extraction model, the control module 22 also controls the training of the assignment model accordingly.

Alternatively, the result class can be assigned in two steps. First, the candidate signal series is binarized. Then, a comparison, also called matching, is performed with the target bit series 35 of the codebook 23.

If the assignment of the analyte type takes place in two steps, then a binarization model must be trained instead of the assignment model, for example. The binarization model maps the image signals of the candidate signal series, i.e., the colored signals and the uncolored signals, onto bit values, i.e., “true” and “false.” When the binarization model is trained, the acquired signal series 31 are mapped onto bit series.

A result output of the binarization model is an output bit series; the objective function detects a difference between the target bit series 35 contained in the annotated data set and the output bit series.

Alternatively, the processing model 28 may also be trained to output a soft assignment that outputs a probability of being a colored signal for each image signal in the signal series 31.

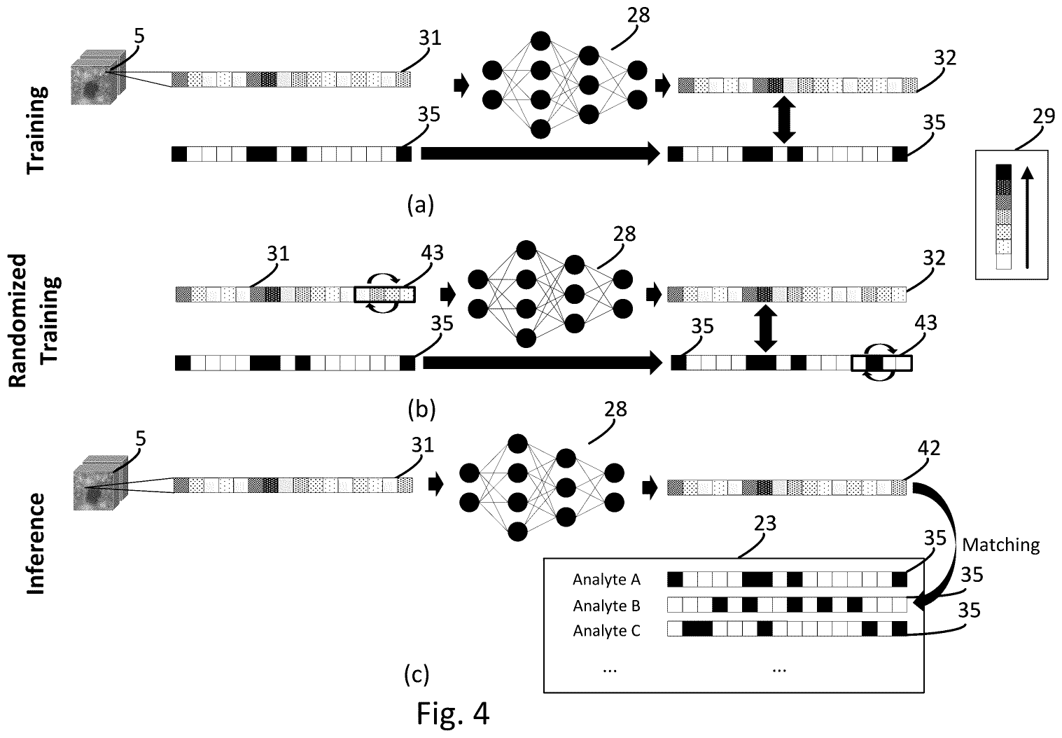

A training of such a soft assignment is schematically illustrated in FIG. 4 (a) for an experiment with 16 coloring rounds. The signal series 31 comprise 16 image signals. Each image signal is assigned a box, wherein the boxes are coded according to the legend 29, with the arrow in the legend 29 pointing to higher values. According to the example shown, analytes are coded using five colored signals in the 16 coloring rounds. A respective analyte type can be identified on the basis of the specific sequence of the colored signals across the coloring rounds. In the example, the result output 32 of the processing model 28 is coded analogously to the coding of the image signals, with the probability that the image signal is a colored signal increasing as indicated by the arrow in the legend.

The candidate signal series can also be binarized by using a heuristic approach. Alternatively, a generative model can also perform the mapping into the binary space.

For example, the generative model used may be one of the following models: an active appearance model (AAMs), a generative adversarial network (GANs), a variational autoencoder (VAEs), an auto-regressive model, or a diffusion model.

In addition to the analyte types to be identified, result classes also comprise at least one class representing image areas or candidate signal series that have to be assigned to the background. Such an assignment to the background always takes place if, for example, the matching to the target bit series 35 is very poor, or if the result of the assignment model for all analyte types yields a very poor value.

According to one alternative, the processing model 28 is an embedding model 33. An embedding model 33 embeds inputs in an embedding space. In particular, the embedding space must be large enough so that the embedding model 33 can suitably learn how to map a signal space of the signal series 31 and/or a binary space of the target bit series 35 onto the embedding space.

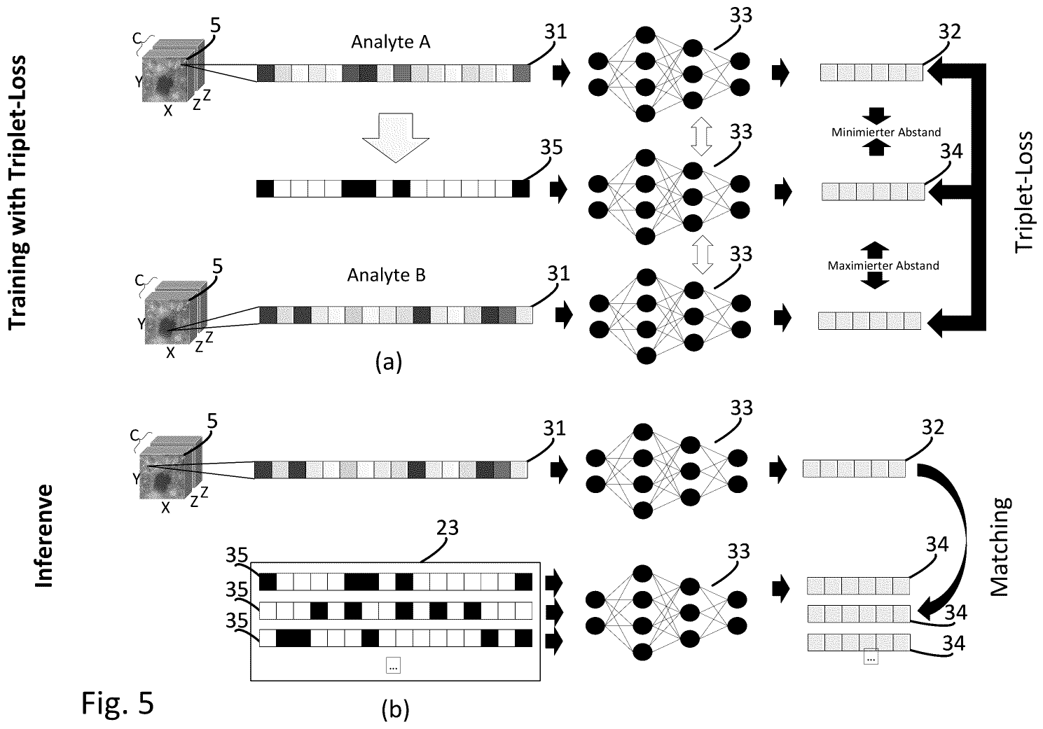

During the training, signal series 31 and target bit series 35 are input into the embedding model 33, and the embedding model 33 outputs the embeddings of the signal series 31 as result outputs 32 and the embeddings of the target bit series 35 as target embeddings 34 (see FIG. 5). An objective function of the embedding model 33 is chosen in such a way that it detects a difference between different embeddings, for example between a result output and a target embedding, between two result outputs, or between two target embeddings. For example, the objective function detects the difference between a result output 32 and a target embedding 34, with the signal series 31 on which the result output 32 is based and the target bit series 35 on which the target embedding 34 is based being assigned to the same result class, here for example the result class “analyte A.”

In addition, the objective function detects a difference between result outputs 32 based on different result classes, for example, a result output 32 that is the embedding of a signal series 31 assigned to the result class “analyte A” and a result output 32 that is the embedding of a signal series 31 assigned to the result class “analyte B.”

In addition, the objective function may also detect a difference between target embeddings 34, wherein the target embeddings are embeddings of target bit series 35 and the target bit series 35 are assigned either to the same result class or to different result classes.

The objective function of the embedding model 33 is now optimized in such a way that the embeddings corresponding to the same result class, for example embeddings that are both assigned to “analyte A” according to the annotated data set have the smallest possible distance in the embedding space. This means that a distance between embeddings of signal series 31 and the corresponding target bit series 35, which are assigned to the result class “Analyte A” in the annotated data set, is minimized by means of a suitable adaptation of the model parameters of the embedding model 33, in the same way as a distance between embeddings of two signal series 31, which are assigned to the same result class.

At the same time, the objective function is selected or optimized, i.e., the model parameters of the embedding model 33 are adjusted so that a distance between the embeddings that are assigned to different result classes according to the annotated data set have the greatest possible distance in the embedding space. This means that the embeddings of signal series 31 and/or the target bit series 35 that are assigned to two different result classes, for example “Analyte A” and “Analyte B”, are embedded in such a way that their distance is as large as possible.

The objective function shown in FIG. 5 (a) is a so-called triplet loss, which simultaneously detects a difference between a result output 32 and a target output 34, which are each assigned to a first analyte type (analyte A here), as well as the difference to a result output 32, which is assigned to another analyte type (analyte B here). However, any other objective function that can simultaneously minimize first distances and maximize second distances as described below can be used as well.

Since the signal series 31, both the signal series 31 and the signal series acquired after the training, and the target bit series 35 are located in different spaces, it may be difficult to suitably optimize the embeddings of the signal series 31 and the target bit series 35 simultaneously. Therefore, the embedding model 33 preferably has two different input paths or processing paths for the signal series 31 and the target bit series 35, which can further reduce a distance between the embeddings of the signal series 31 and the target bit series 35, and thus further improve both the training and the matching. In the inference, the signal series 31 are then input into the input paths provided for the signal series 31.

According to one alternative, the signal series 31 and the target bit series 35 share the same input path.

According to a further alternative, a candidate group of the candidate objective functions can be calculated first during the training when the objective function is calculated. A candidate objective function differs from the normal objective functions of the models described above in that one of the colored signals is not considered in the calculation of the candidate objective functions. A candidate group corresponds to an input signal series 31; now, as many candidate objective functions are successively computed in the signal series 31 as the input signal series 31 contains colored signals, leaving out a different one of the colored signals in each of the candidate objective functions of a candidate target group. Then, an objective function of choice is selected from the candidate group. The objective function of choice is the candidate objective function of the candidate group that has either a second largest, a third largest, or a fourth largest difference between the result output and the target output.

Since during acquisition of the image series in the signal series 31, it sometimes happens that an image signal of a signal series 31 is not recognized as a colored signal, even though, according to a target bit series 35, a colored signal should be present at the corresponding position or in the corresponding coloring round, a model can be specifically trained, by means of candidate objective function or candidate groups and a selection of an objective function of choice, to know that the acquired signal series 31 to have errors.

According to a further alternative, the image signals of the signal series 31 can be swapped during the training in such a way that the colored and uncolored signals in the swapped signal series again correspond to a sequence of another analyte type. A sequence of true and false values in the target bit series is adapted accordingly, so that signal series of analyte types for which no signal series are available can be generated as well (see also FIG. 4 (b)). This kind of training can be carried out for all models mentioned above.

The processing model 28 may, for example, be the classification model that outputs a probability for each image signal in a signal series 31 as to whether the image signal is a colored signal. During the training, the signal series 31 is input into the processing model 28, and the result output 32 should then have a high probability for the image signals that correspond to a true value in the target bit series 35 that the respective image signal is a colored signal.

If the sequence of image signals of individual or a plurality of the coloring rounds in the signal series 31 is swapped, as indicated for example in FIG. 4 (b) by means of the arrows on the swapped coloring rounds 43 of the signal series 31, the entries of the same coloring rounds in the target bit series 35 must be swapped as well, as indicated by the arrows on the swapped coloring rounds 43 of the target bit series. Accordingly, the objective function then detects a difference between the result output 32 and the target bit series 35 with the respectively swapped coloring rounds 43.

Once the various models of the analyte data evaluation system 1 have been trained, the inference can be carried out in step S3, i.e., new data can be incorporated and analyzed with the plurality of models of the analyte data evaluation system 1.

According to the first embodiment, images 5 of the image series 19 are acquired first. For this purpose, different markers are coupled to the analytes 39 present in the sample in accordance with a codebook 23 and then an image 5 of the sample is acquired. According to the first embodiment, markers with, for example, n=3 different colors, for example orange, yellow, and green, are coupled to the analytes 39 in each marking round. After the coupling, three images are acquired in three coloring rounds, i.e. one per coloring round. Each of the images is acquired in a different fluorescence contrast with the fluorescence illumination device 13 being operated at different excitation wavelengths or with different filters, in this case, for example, wavelengths to excite fluorescence in orange, yellow, and green. Accordingly, a colored signal is captured for analytes 39 coupled to orange-colored markers in the first coloring round, which is acquired with the orange-colored fluorescence contrast, for example, while an uncolored signal is captured for analytes 39 coupled to yellow or green markers. According to the embodiment, an image is acquired in orange-colored fluorescence contrast in a first coloring round after the coupling, an image is acquired in green fluorescence contrast in a second coloring round after the coupling, and an image is acquired in yellow fluorescence contrast in a third coloring round after the coupling. The codebook 23 shown in FIG. 3 contains a code word coded in the contrast colors of the coloring rounds instead of a target bit series 35. This means that an analyte A is coupled to an orange-colored marker during the first to the third coupling, and to a green marker during the fourth and fifth coupling. Since an image is acquired in orange contrast in the first coloring round after the coupling, an “O” in the code word corresponds to a bit series “100,” a “Y” (from the English yellow) corresponds to “010” in the bit series and a “G” corresponds to “001” in the bit series. The corresponding analytes A, B, and C are marked in the coloring rounds R1, R2, R3, and R4 of the images 5 of the image series 19 (see FIG. 3).

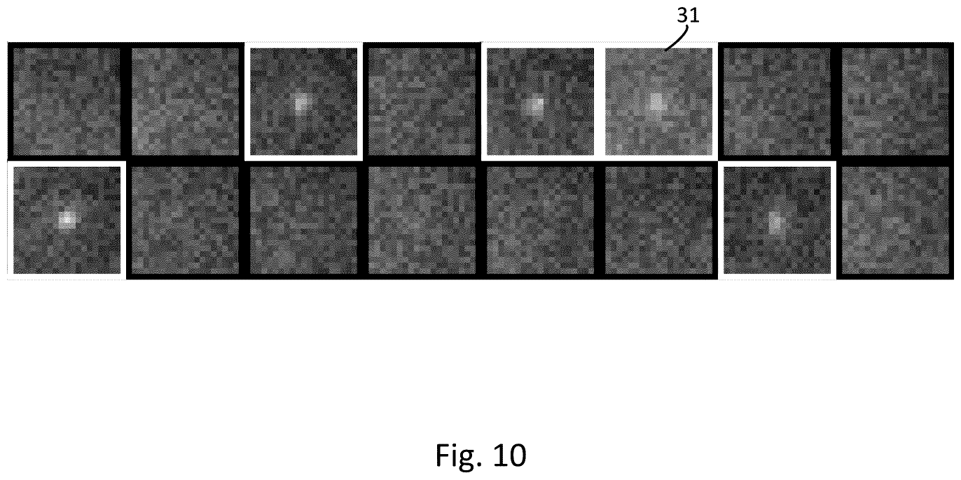

According to one alternative, only a single color contrast, two color contrasts, or more than two color contrasts could be used when acquiring the images 5 of the image series 19, with the number of color contrasts preferably corresponding to the number of the different markers used. FIG. 10 schematically shows sections of images 5 of an image series, with the sections outlined in black containing only pixels with uncolored signals, while pixels with colored signals are schematically shown in the center of each of the sections outlined in white. The images in the upper row are acquired with a first color contrast, the images in the lower row are acquired with a second color contrast. In this case, the first coloring round then corresponds to the image at the top left and the last coloring round to the image at the bottom right, i.e., the signal series 31 shown comprises colored signals in the coloring rounds 2, 5, 9, 11, and 14, which can then be used to identify an analyte type.

After the image series 19 is acquired, the images 5 of the image series 19 are registered to each other and the image series 19 is stored in the memory module 20.

Then, the control module 22 inputs the data into the candidate extraction module 27. The candidate extraction module 27 uses the completely trained candidate extraction model according to the embodiment to identify the candidate signal series.

After the candidate extraction module 27 has output the candidate signal series, the output candidate signal series may be supplied to the processing module 24 for a post-processing by the control module 22.

The control module 22 receives the candidate signal series from the candidate extraction module 27 and combines adjacent image areas into image regions if candidate signal series were captured in each of the adjacent image areas. The combining of the adjacent image areas into image regions also comprises a non-maximal suppression.

After the control module 22 has specified the image regions, the specified image regions are checked again. When the image regions are checked, the control module 22 determines, for example, whether the image regions exceed a maximum size, whether the shapes of the specified image regions indicate that two of the image regions should actually be separated from each other, for example because there are only a few bridge pixels between two image regions. In addition, the control module 27 can reject image regions if they do not reach a minimum size.

The control module 22 determines image region signal series relating to the candidate image regions based on the signal series of the combined image areas.

Subsequently, the image region signal series are transmitted from the control module 22 to the processing model 24 as candidate signal series in order to determine the respective analyte type or the result class of the candidate signal series based on the image region signal series.

According to an alternative embodiment, the candidate extraction module 27 transmits the candidate signal series directly to the processing module 24.

The processing module 24 uses one of the processing models described above to assign the result class to the candidate signal series or the image region signal series. As described above, the assignment of the result class may also reveal that the candidate signal series does not match any of the analyte types of the codebook 23 and is therefore assigned to the background.

As described above, the processing model can directly output a result class of input signal series 31.

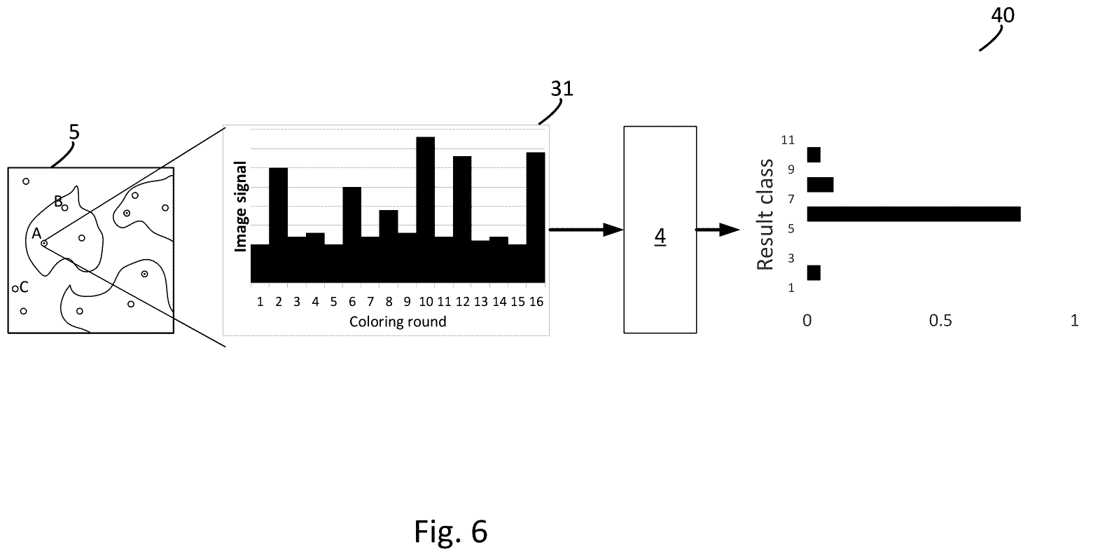

Alternatively, however, the processing model can also output a probability distribution 40 across the result classes (see schematic FIG. 6).

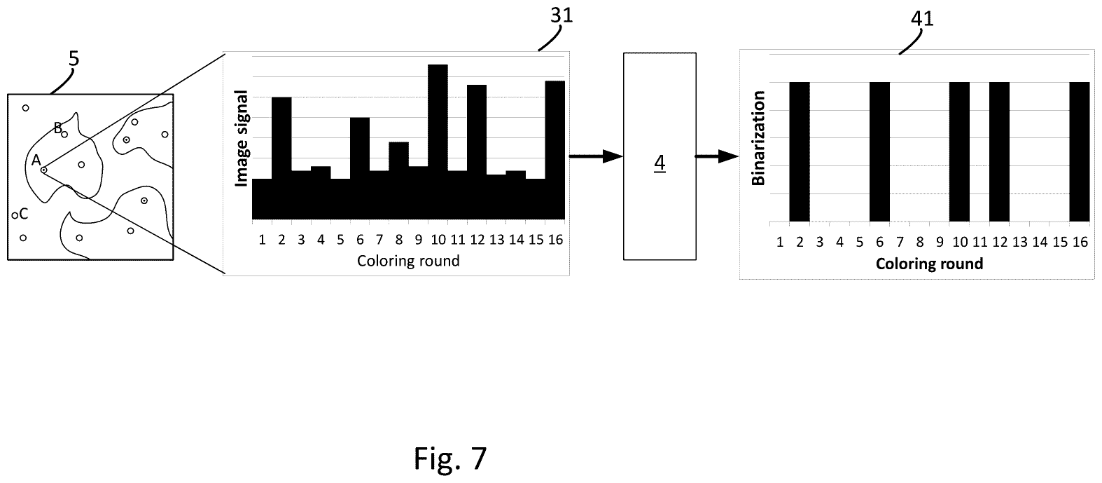

As described above, the processing model may also have been trained to output a binarization 41, also called a bit series, of an input signal series 31 as the result output. The binarization is then used to match the target bit series 35 of the codebook 23 (see schematic FIG. 7).

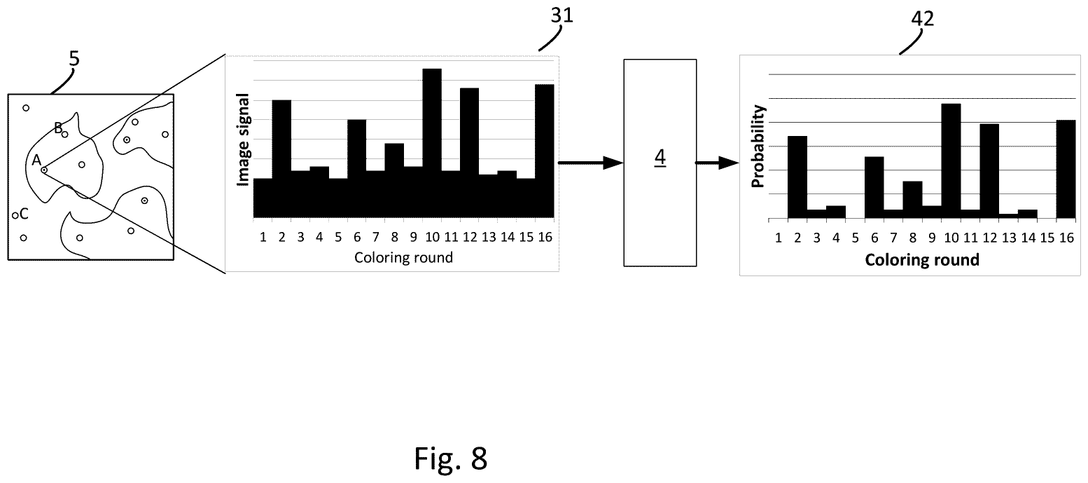

According to a further alternative, the processing model outputs a probability, i.e., a probability series 42, for each image signal in the input signal series 31, with the probability indicating whether the respective image signal is a colored signal (see schematic FIG. 8 or FIG. 4 (c) as well). The probability series 42 is then used for the comparison, i.e. the matching with the codebook 23.

If the processing model 28 is an embedding model 33 as described above with regard to the training, the matching is carried out in the embedding space (see schematic FIG. 5 (b) in this regard). A simple interpretation of the embedding of signal series 31 is not possible in connection with embedding models 33, because a matching is performed, for example, by determining a distance to the embeddings of the target bit series 35 of the codebook 23.

According to one alternative, a matching for the alternatives described above in which the processing model outputs either a binarization 41, a probability series 42, or an embedding can be performed by using a matrix multiplication, wherein the respective result output of the processing model is multiplied by a codebook matrix, wherein the codebook matrix comprises the target bit series 35 as entries. The result of the matrix multiplication is a vector comprising one entry for each result class. The entry with the highest value then corresponds to a most probable result class.

Preferably, the matrix multiplication and the codebook matrix are implemented in a final layer of the processing model.

How to interpret the result of the matrix multiplication will be explained in more detail below on the basis of an example. According to the present example, an experiment comprises 16 coloring rounds. The different analyte types are coded in such a way that each of the analyte types to be identified in the experiment are marked with a marker in 5 of the 16 coloring rounds. This means that, in the experiment, the image areas that capture image signals from analytes should have exactly 5 colored signals and 11 uncolored signals across the 16 coloring rounds. Correspondingly, the target bit series 35 in the codebook 23 each have 5 true values and 11 false values.

According to this example, the processing model is the binarization model. The processing model is trained to output a true value for all colored signals and a false value for all uncolored signals. Thus, the result output is a bit series. The matrix multiplication is performed in such a way that a scalar product of the result output with the respective target bit series 35 is calculated for each of the signal result classes in the codebook matrix. The scalar product of the result output, which is the binarized signal series, and the corresponding target bit series 35 should equal “5” as the result of the scalar product, because in each case a true value in the result output, i.e., a “1,” meets a “1” in the target bit series 35. Accordingly, for target bit series 35 having a matching true value in only 4 matching rounds of the 16 coloration rounds, the sum is 4, for target bit series 35 having a matching true value in only 3 matching rounds of the 16 coloration rounds, the sum is 3, and so on.

If the result output of the processing model for each of the image signals in a signal series is the probability distribution as to whether the respective image signal is a colored signal, then the result of the matrix multiplication for each result class is equal to the sum of the probabilities that the image signals corresponding to the true signals of the respective target bit series 35 of a result class are colored signals. If, for example, the probability is “0.9” for all true values of a target bit series 35 in a corresponding signal series for each of the image signals corresponding to the true values of the target bit series, then the sum is “4.5.”

As described above, a comparison with the embeddings of the target bit series 35 can also be performed by means of a matrix multiplication, if an embedding model 33 is used.

Likewise, the steps described above for determining an image region may still be performed after the assignment of the analyte type. For each of the analyte types or signal components to be identified, for example, the codebook 23 comprises analyte context information that indicates, for example, a maximum size for an analyte region depending on the analyte type, that indicates, for example, where in a sample, for example in which of the above-described components of a cell the respective analyte types may occur, or which of the analyte types may be colocalized in the sample at which locations. The analyte region determination may accordingly take into account this analyte context information and, if appropriate, combine or separate analyte regions, determine new analyte region signal series in accordance with the combination or separation, and initiate a reassignment of the analyte type for newly determined analyte region signal series.

According to a step S4, a check is performed as to whether the assignment by means of the assignment module 33 indicates that more than one threshold value of candidate signal series does not correspond to one of the analyte types to be identified. If the threshold is exceeded, the corresponding candidate signal series are included in the annotated data set for training the candidate extraction model and the training of the candidate extraction model is repeated with the extended annotated data set.

List of Reference Numerals

| | |
|---|---|
| 1 | Analyte data evaluation system |
| 2 | Microscope |
| 3 | Control device |
| 4 | Evaluation device |
| 5 | Microscope image |
| 6 | Stand |
| 7 | Nosepiece |
| 8 | Mounted objective |
| 9 | Specimen stage |
| 10 | Holding frame |
| 11 | Specimen carrier |
| 12 | Microscope camera |
| 13 | Fluorescent illumination device |
| 14 | Transmitted light illumination device |
| 15 | Overview camera |
| 16 | Field of view |
| 17 | Mirror |
| 18 | Screen |
| 19 | Image series |
| 20 | Memory module |
| 21 | Channel |
| 22 | Control module |
| 23 | Codebook |
| 24 | Processing module |
| 25 | Image area |
| 26 | Background image area |
| 27 | Candidate extraction module |
| 28 | Processing model |
| 29 | Legend |
| 31 | Signal series |
| 32 | Result output |
| 33 | Embedding model |
| 34 | Target embedding |
| 35 | Target bit series |
| 36 | Segmentation mask |
| 37 | Fully convolutional network |
| 38 | Fully connected network |
| 39 | Analyte |
| 40 | Probability distribution |
| 41 | Binarization |
| 42 | Probability series |
| 43 | Swapped coloring rounds |

US Patent Application
Carl Zeiss Microscopy GmbH
P345252US

1. Method for training a machine learning system with a processing model, wherein the processing model is trained to assign a result class to signal series from image areas of an image series, the image series is generated by marking analytes with markers in a plurality of coloring rounds and detects the markers with a camera, the camera acquires an image of the image series in each coloring round, the markers are selected in such a way that the signal series of analytes in an image area across the image series comprise colored signals and uncolored signals, the colored and uncolored signals of the signal series of analytes have at least one particular ratio of one of the colored and/or uncolored signals of the respective signal series to at least one other of the colored and/or uncolored signals of the respective signal series, and/or the signal series of analytes have a characteristic signature comprising the at least one particular ratio, comprising:
providing an annotated data set, wherein the annotated data set comprises signal series for different result classes to be identified, as well as corresponding target outputs, the result classes comprise at least one class for each analyte type to be identified, and signal series of analytes have a specific sequence of colored and uncolored signals, from which an analyte type can be assigned to the signal series, and
optimizing an objective function by adjusting the model parameters of the processing model, wherein the objective function is calculated based on a result output from the processing model and the target output.

2. Method according to claim 1, wherein the annotated data set further comprises signal series from background image areas, wherein the background image areas are image areas of the image series in which no signals from analytes are captured, and the target output for background image areas forms at least one distinct class in the set of signal components.

3. Method according to claim 1, wherein the processing model is a classification model, the result output indicates a result class of the signal series, or the result output is a probability distribution, each indicating the probability of belonging to one of the result classes, and the objective function detects a difference between the result output and the target output.

4. Method according to claim 1, wherein an objective function is optimized in a plurality of rounds, and, in some of the rounds, the sequence of the colored and uncolored signals of the signal series is changed such that the changed sequence corresponds to a sequence of a different one of the analyte types to be identified, and the target output corresponding to the changed sequence is used accordingly for the optimization of the objective function.

5. Method according to the preceding claim 1, wherein the objective function is a classification loss and the result output for each entry has a value between 0 and 1 indicating a probability that the respective signal series belongs to the respective result class.

6. Method according to the preceding claim 1, wherein the target output is a target bit series, and the target output comprises a true bit for each colored signal in the signal series and a false bit for each uncolored signal.

7. Method according to the preceding claim 6, wherein the target output for signal series of background image areas comprises only false values.

8. Method according to claim 6, wherein the result output is a result bit series, wherein the processing model is trained to assign a true bit to each colored signal in the signal series and a false bit to each uncolored signal in the signal series, and the objective function detects a difference between the result bit series and the target output.

9. Method according to claim 6, wherein the result output is a probability distribution in which each image signal of the signal series is associated with a probability that the image signal is a colored signal or not, and the objective function detects a difference between the result output and the target output.

10. Method according to claim 6, wherein the result output for each of the image signals has a value between 0 and 1 indicating a probability that the respective image signal is a colored signal.

11. Method according to claim 1, wherein the processing model is a fully convolutional network, which is either trained directly as a fully convolutional network or has been trained as a classification model with fully connected layers with signal series of individual image areas, and after the training, the classification model is transformed, through replacement of the fully connected layers with convolutional layers, into the fully convolutional network that can process the signal series of all image areas of the image series simultaneously.

12. Method according to claim 2, wherein a calculation of the objective function comprises:
calculating a candidate group of candidate objective functions for each signal series of analytes, wherein, for each of the candidate objective functions, a different one of the colored signals of the signal series is disregarded in the calculation of the candidate objective function, for example by being set to “zero” or replaced by an uncolored signal, and/or one or more image signals of the input signal series for signal series of a background image area for each of the candidate objective functions are not taken into account in the calculation of the candidate objective functions by omitting the corresponding colored signals from the calculation or replacing them with uncolored signals, and
selecting an objective function of choice from the candidate group, wherein the objective function of choice is the candidate objective function of the candidate group that has either a second largest or a third largest or a fourth largest difference between the target bit series and the result bit series.

13. Method according to the preceding claim 6, wherein the processing model is an embedding model that determines an embedding in an embedding space for the embedding inputs, the embedding inputs comprise the signal series and the target outputs, the result outputs comprise the embeddings of the signal series, the target embeddings comprise the embeddings of the target outputs, and the optimization of the objective functions simultaneously minimizes the difference between the embeddings of the embedding inputs of the same result class and maximizes the difference between the embeddings based on the embedding inputs of different result classes.

14. Method according to claim 6, wherein an objective function is optimized in a plurality of rounds, and, in some of the rounds, comprises a randomization of the signal series, wherein the randomization comprises one or more of the following:
swapping a sequence of the image signals of the signal series and correspondingly swapping the corresponding entries of the target output, and
randomly selecting a first number of colored signals and a second number of uncolored signals from the set of signal series and producing the respectively corresponding target output.

15. Method according to claim 1, wherein an objective function is optimized in a plurality of rounds and, in some of the rounds, comprises an augmentation of the signal series, wherein the augmentation comprises one or more of the following:
replacing a single one of the colored signals of the signal series with an uncolored signal, wherein the uncolored signal is generated either by lowering the colored signal or by replacing the colored signal with an image signal from the vicinity of the image area of the signal series, from another coloring round or from another location in the sample,
randomly adding noise to some of the image signals of the image series, for example the image signals of a signal series, one of the images of the image series or all images of the image series,
shifting and/or rotating the images of the image series with respect to each other, for example by less than 2 pixels or less than or equal to one pixel, for example half a pixel,
replacing a single one of the uncolored signals of the signal series with a colored signal,
shifting the image signals of at least one of the images of the image series by a constant value, and
shifting the image signals of the signal series by a constant value.

16. Method according to claim 1, wherein the signal series is transformed into a transformed input signal series by means of a transformation, and the transformed signal series is input into the processing model, wherein the transformation comprises in particular one or more of the following:
a main component analysis,
a main axis transformation,
a singular value decomposition,
a normalization, wherein the normalization comprises a normalizing of the image signals across an image or a normalization of the image signals across a signal series, or both.

17. Method according to claim 1, wherein the annotated data set is generated with at least one of the following steps:
simulating signals of the different markers using a representative background image and a known point spread function of the microscope,
generating the annotated data set by means of a generative model trained on the basis of comparable data,
acquiring reference images comprising at least one background image and, for each of the background images for each of the analyte types, at least one image in which analytes of the respective analyte types are marked,
performing a classical method for the spatial identification of analytes,
acquiring a representative background image and subtracting the image signals of the representative background image pixel by pixel from the image signals of the image series on which the annotated data set is based, prior to providing the annotated data set, so that the annotated data set comprises only background-corrected signal series.

18. Method according to claim 1, wherein the training of the processing model comprises a completely new learning of the processing model or transfer learning from a pre-trained processing model, wherein the pre-trained processing model is selected from a set of pre-trained processing models based on, for example, context information.

19. Method for training a machine learning system with a candidate extraction model for extracting candidate image series from an image series, wherein the image series is generated by marking analytes with markers in a plurality of coloring rounds and detecting the markers with a camera, the camera captures an image of the image series in each coloring round, the markers are selected in such a way that the images signals of the analyte in an image area across the image series comprise colored and uncolored signals, comprising:
providing of an annotated data set, and
optimizing of an objective function by adjusting the model parameters of the candidate extraction model, wherein the objective function detects a difference between a result output from the candidate extraction model and a target output, characterized in that
the annotated data set comprises at least one signal series of an image area that captures image signals from an analyte, as well as a signal series of an image area that captures image signals from a background, and for each of the signal series, a target output indicating whether or not the signal series comprises image signals from an analyte.

20. Method according to claim 19, wherein the candidate extraction model is trained to identify candidate signal series on the basis of a number of colored signals, wherein the colored and uncolored signals are identified based on at least one particular ratio of one of the colored and/or uncolored signals of the respective signal series to at least one other of the colored and/or uncolored signals of the respective signal series and/or to identify the candidate signal series, respectively, based on a characteristic signature with the at least one particular ratio.

21. Method according to claim 19, wherein the candidate extraction model is a fully convolutional network, which has been trained as a classification model with fully connected layers with signal series of individual image areas, and after the training, the classification model is transformed, through replacement of the fully connected layers with convolutional layers, into the fully convolutional network that can process the signal series of all image areas of the image series simultaneously.

22. Method according to claim 19, wherein the candidate extraction model is a semantic segmentation model and the annotated data set comprises, for each image of the image series, a segmentation mask that assigns to each image area a value indicating whether or not the image area is a candidate image area that captures a candidate signal series across the image series, wherein the value is, for example, a bit indicating whether or not the image area is a candidate area.

23. Method according to claim 19, wherein the candidate extraction model is an image-to-image model and a processing map is an image-to-image map, and the target output in the annotated data set is either a distance value indicating how far the image area is from a closest image area with a candidate image series or a probability value indicating the probability that a candidate image series was captured in the image area.

24. Method according to claim 19, wherein the candidate extraction model is implemented as a detection model and outputs a list of image area that detect a candidate signal series.

25. Method according to claim 19, wherein the annotated data set is generated with at least one of the following steps:
simulating signals of the different markers by using a representative background image and a known point spread function of the microscope,
generating the annotated data set by means of a generative model trained on the basis of comparable data,
acquiring reference images comprising at least one background image and, for each of the background images, at least one image in which each of the analytes to be identified is marked,
performing a classical method for the spatial identification of analytes.

26. Method according to claim 19, wherein the annotated data set is generated with a method for training a machine learning system with a processing model, wherein the processing model is trained to assign a result class to signal series from image areas of an image series, the image series is generated by marking analytes with markers in a plurality of coloring rounds and detects the markers with a camera, the camera acquires an image of the image series in each coloring round, the markers are selected in such a way that the signal series of analytes in an image area across the image series comprise colored signals and uncolored signals, the colored and uncolored signals of the signal series of analytes have at least one particular ratio of one of the colored and/or uncolored signals of the respective signal series to at least one other of the colored and/or uncolored signals of the respective signal series, and/or the signal series of analytes have a characteristic signature comprising the at least one particular ratio, comprising:
providing an annotated data set, wherein the annotated data set comprises signal series for different result classes to be identified, as well as corresponding target outputs, the result classes comprise at least one class for each analyte type to be identified, and signal series of analytes have a specific sequence of colored and uncolored signals, from which an analyte type can be assigned to the signal series, and
optimizing an objective function by adjusting the model parameters of the processing model, wherein the objective function is calculated based on a result output from the processing model and the target output.

27. Method according to claim 19, further comprising the swapping of a sequence of the image signals from the signal series of the image areas that capture image signals of an analyte before an input into the candidate extraction model.

28. Method according to claim 19, wherein the optimization of the objective function comprises a plurality of training rounds, a training round comprising:
selecting training data from the annotated data set,
determining the objective function on the basis of the training data,
identifying misclassified signal series of a background area within a first predetermined radius around an image area in which an analyte has been captured, and, for example, outside a second predetermined radius around the image area, wherein the first predetermined radius is larger than the second predetermined radius,
using the identified misclassified signal series as training data in a next training round, in addition to the training data selected in the next training round.

29. Method according to claim 28, wherein a misclassified signal series that is immediately adjacent to a pixel to which an analyte has been correctly assigned is not used as training data in the next training round.

30. Method for training a machine learning system with an association model, wherein the association model comprises a processing model and a candidate extraction model, wherein the processing model has preferably been trained by means of the method according to claim 1, and the association model, wherein the processing model and the candidate extraction model have a common input layer and the processing model has preferably been trained with candidate signal series as part of the training.

31. Method for assigning image areas of an image series to result classes by means of an analyte data evaluation system with a processing model, wherein the processing model has been trained to assign a result class to image areas of the image series, the image series is generated by marking analytes with markers in a plurality of coloring rounds and detecting the markers with a camera, the camera captures an image of the image series in each coloring round, the markers are selected such that the signal series of analytes in an image area across the image series comprise colored signals and uncolored signals, the colored and uncolored signals of the signal series of analytes have at least one particular ratio of one of the colored and/or uncolored signals of the respective signal series to at least one other of the colored and/or uncolored signals of the respective signal series and/or the signal series of analytes have a characteristic signature, comprising the at least one particular ratio, the result classes comprise at least one class for each analyte type to be identified, and signal series of analytes each have, for each analyte type to be identified, a specific sequence of the colored and uncolored signals by means of which the respective analyte types can be assigned to the signal series of analytes, comprising:
extracting a plurality of signal series from a respective image area of the image series,
inputting the signal series into the processing model,
outputting the result outputs,
assigning the result classes based on the result outputs.

32. Method according to claim 31, wherein the processing model has been trained to either output as the result output the result class of the signal series or to output as the result output a probability distribution across the result classes, each indicating the probability of belonging to one of the result classes.

33. Method according to claim 32, wherein the processing model is either a classification model, a segmentation model, or an image-to-image model, wherein the result outputs of the classification model output one of the result classes for each input image area, the segmentation model outputs a segmentation mask in which a result class is assigned to each of the image area of the image series, and the image-to-image model outputs a probability distribution across the result classes for each image area.

34. Method according to claim 31, wherein the processing model is a classification model trained to output as the result output an output bit series, wherein the processing model assigns a true value in the bit series to the colored signals of the signal series and assigns a false value in the bit series to the uncolored signals.

35. Method according to claim 31, wherein the processing model has been trained to output, for each signal series, a probability distribution in which each image signal of the signal series is assigned a probability indicating the likelihood that the image signal is a colored signal.

36. Method according to claim 34, wherein the assignment of the result classes comprises a multiplication of the result output by an analyte matrix or a determination of a smallest distance, wherein the analyte matrix comprises target bit series of the result classes, such that a result of the multiplication for each target bit series outputs a value, and a result class corresponding to a highest value of the respective signal series is assigned as a result class, or, after the determination of a smallest distance based on the result output and the target bit series corresponding to the different result classes, the result class corresponding to the target bit series with the smallest distance is assigned to the respective signal series as a result class.

37. Method according to claim 36, wherein the result output of the processing model is input into a convolution layer, wherein the convolution layer implements the analyte matrix and the multiplication of the result output by the analyte matrix.

38. Method according to claim 31, wherein the processing model is an embedding model that calculates the embeddings from the embedding inputs, wherein the embedding inputs comprise the signal series and the target bit series, such that the result output is a result embedding and the embedding of the target bit series is a target embedding, wherein the embedding model has been trained to map signal series onto the embedding space such that a difference between the embeddings of the embedding inputs from the same result class is minimized and a difference between the embeddings of the embedding inputs from different result classes is maximized, and the assignment of the result class is carried out on the basis of the result embedding and the target embeddings of the different result classes.

39. Method according to claim 38, wherein the assignment of the result classes comprises a multiplication of the result output by a target embedding matrix or a determination of a smallest distance, wherein the target embedding matrix comprises the embeddings of the target bit series of the result classes, such that a result of the multiplication outputs a value for each result class and the result class with the highest value is a most probable result class, and the determination of a smallest distance comprises a calculation of the distances between the result embedding and the target embeddings and a result class corresponding to the target embedding with the smallest distance is assigned to the respective signal series as the result class.

40. Method according to claim 39, wherein the result output of the processing model is input into a convolution layer, wherein the convolution layer implements the target embedding matrix and the multiplication of the result output by the target embedding matrix.

41. Method according to claim 39, wherein, depending on the distance for each analyte type, a probability is output as to whether the signal series corresponds to the respective analyte type.

42. Method according to claim 31, wherein the extraction of a plurality of signal series further comprises:
filtering out candidate signal series from the extracted signal series, wherein a ratio of at least one of the colored and/or uncolored signals of a candidate signal series to at least one other of the colored and/or uncolored signals of the respective signal series is a characteristic ratio and/or a candidate signal series comprises a characteristic signature with the at least one characteristic ratio, such that if the signal series comprises at least one characteristic ratio and/or the characteristic signature, the signal series is considered a candidate signal series, and
assigning the result classes based on the filtering of the candidate signal series.

43. Method according to claim 42, wherein the filtering out of candidate signal series is performed with a candidate extraction model, with the candidate extraction model being selected from a set of candidate extraction models based on, for example, a sample type, an experiment type, or a user ID.

44. Method according to claim 43, wherein the candidate extraction model has been trained to identify the colored and uncolored signals based on at least one particular ratio of one of the colored and/or uncolored signals from the respective signal series to at least one other of the colored and/or uncolored signals from the respective signal series and/or to identify the candidate signal series on the basis of a characteristic signature comprising the at least one particular ratio.

45. Method according to claim 43, wherein the candidate extraction model is a semantic segmentation model that outputs a semantic segmentation mask that assigns to each image area a semantic class indicating whether or not the image area captures an analyte.

46. Method according to the preceding claim 45, wherein the candidate extraction model is a patch classifier and assigns the value to each image area by means of a sliding window method.

47. Method according to claim 43, wherein the candidate extraction model is a fully convolutional network and was trained as a classification model with fully connected layers with signal series from individual image areas, and after the training, the classification model is transformed, through replacement of the fully connected layers with convolutional layers, into the fully convolutional network that can process the signal series of all image areas of the image series simultaneously in the fully convolutional network.

48. Method according to claim 43, wherein the candidate extraction model is an image-to-image model and performs an image-to-image mapping that assigns to each image area a distance value indicating how far the image area is from the closest image area having a candidate signal series, or that assigns to each pixel a probability of being an image area with a candidate signal series.

49. Method according to claim 43, wherein the candidate extraction model is implemented as a detection model and outputs a list of image area with a candidate signal series.

50. Method according to claim 43, wherein the method also comprises the transformation of the signal series by means of a main axis transformation or a singular value decomposition prior to the verification that the signal series is a candidate signal series, and wherein the transformed signal series is used to verify, whether the signal series is a candidate signal series, wherein, for example, only a subset of the components of the transformed signal series is used, for example the first component is preferably omitted or the first component and the last component or the first and the last two components are omitted.

51. Method according to claim 43, wherein the image areas comprise, for example, only one pixel each, an area of contiguous pixels, or a contiguous volume in an image stack, and are input into the candidate extraction model, for example, as a tensor.

52. Method according to claim 43, wherein the processing model and the candidate extraction model form a common assignment model with a common input layer and wherein preferably, the signal series are either first processed by the candidate extraction model and the signal series identified as candidate signal series are subsequently processed by the processing model in order to assign a result class to the candidate signal series, or
the signal series are processed independently of each other in the two models.

53. Method according to claim 52, wherein the outputs from two models are combined in a final mapping step that is independent of the mapping model, or the outputs from the two models are combined in an output layer of the assignment model such that signal series that are not identified as candidate signal series by the candidate extraction model are assigned to the background and the identified candidate signal series are assigned to a result class according to the assignment of the processing model.

54. Method according to claim 31, further comprising the determination of an image region, the determination of an image region comprising:
combining adjacent image areas into an image region if the adjacent image areas comprise candidate signal series, wherein the combining of adjacent image areas comprises non-maximal suppression, for example.

55. Method according to the preceding claim 54, wherein the determination of an image region furthermore comprises: verifying the image regions, wherein the verifying of an image region comprises at least one of the following:
separating the image region into two or more image regions if the image region exceeds a maximum size,
separating the image region into two or more image regions if the image regions are each connected only by a few bridge pixels and/or it is apparent from a shape of the image region that two image regions intersect here,
separating the image region based on analyte context information, wherein the analyte context information comprises, for example: information about a size of an image region depending on the analyte type, information about a location of an image region in a sample, information about co-localizations of certain analyte types in certain areas or in a location in a sample, the expected analyte densities depending on a location of the image region in a sample;
discarding image regions if an image region falls below a minimum size or has a shape that cannot be reliably assigned to an analyte type.

56. Method according to the preceding claim 55, wherein the maximum size of the image region is selected depending on the point spread function of an imaging device.

57. Method according to the preceding claim 54, wherein the determination of an image region furthermore comprises:
determining an image region signal series based on the signal series of the image areas that the image region is comprised of, and
the assigning of the result class on the basis of the image region signal series comprises combining image signals from adjacent pixels into a combined image signal of the image region.

58. Method according to claim 54, wherein the determination of an image region is performed after having checked whether the signal series is a candidate signal series and before the assignment of the result class and/or after the assignment of the result class.

59. Method according to claim 54, further comprising:
use of the identified analyte type as analyte context information for the determination of the image region, with the analyte context information comprising in particular:
Information about a size of an analyte region depending on the analyte type,
information about a location of an analyte type in a sample,
Information about a co-localization of certain analyte types.

60. Method according to claim 31, further comprising:
determining a confidence of the assignment of the result class, wherein the confidence is preferably determined based on an entropy of the result output, or based on a ratio between an assignment probability of a most likely result class to a second most likely result class.

61. Method of claim 60, wherein, in addition to the result output of the processing model, the result output of the candidate extraction model is also considered in the determination of a confidence.

62. Method according to claim 31, further comprising:
generating an extended annotated data set based on the extracted signal series and the assignment of the signal series to a result class, and
implementing the method for training a machine learning system according to a training method with at least the extended annotated data set as the annotated data set, wherein the train method is for training a machine learning system with a processing model, wherein the processing model is trained to assign a result class to signal series from image areas of an image series, the image series is generated by marking analytes with markers in a plurality of coloring rounds and detects the markers with a camera, the camera acquires an image of the image series in each coloring round, the markers are selected in such a way that the signal series of analytes in an image area across the image series comprise colored signals and uncolored signals, the colored and uncolored signals of the signal series of analytes have at least one particular ratio of one of the colored and/or uncolored signals of the respective signal series to at least one other of the colored and/or uncolored signals of the respective signal series, and/or the signal series of analytes have a characteristic signature comprising the at least one particular ratio, comprising:
providing an annotated data set, wherein the annotated data set comprises signal series for different result classes to be identified, as well as corresponding target outputs, the result classes comprise at least one class for each analyte type to be identified, and signal series of analytes have a specific sequence of colored and uncolored signals, from which an analyte type can be assigned to the signal series, and
optimizing an objective function by adjusting the model parameters of the processing model, wherein the objective function is calculated based on a result output from the processing model and the target output.

63. Method according to claim 31, the method further comprising:
analyzing a quality of the images of the image series,
repeating the acquisition of one of the images of the image series if the quality is not sufficiently high, wherein the quality is determined based on, for example, one or more of the following:
a relative signal strength of the images to each other,
pixels present in the individual images having image signals above a certain threshold,
an unexpected distribution of identified analyte types, wherein the analyte types were disproportionately identified based on a particular one of the images of the image series,
a machine-learned quality assessment model trained to determine a quality score for an image, a sub-image, or pixels.

64. Method according to claim 31, wherein the method further comprises the performance of a background correction of the image signals from the image series prior to the inputting of the signal series into the processing model, wherein the background correction comprises one or more of the following:
a rolling-ball method,
a filtering such as a top-hat method, a homomorphic filtering, a low-pass filtering, wherein the result of the low-pass filtering is subtracted from the signal, or a temporal filtering,
a background correction by means of an image-to-image model,
a background correction by means of mixed models,
a background correction by means of a mean-shift method,
a background correction by means of a main component analysis,
a background correction by means of a non-negative matrix factorization,
a background correction by means of an excitation of the auto-fluorescence with at least one specific laser for all image areas of the image series, wherein the specific laser corresponds exactly to an excitation spectral range of one of the markers used and the analytes are not yet marked with markers, or
a background correction by means of an excitation of the auto-fluorescence by means of a non-specific laser for all image areas of the image series.

65. Method according to claim 31, wherein the processing model is selected from a set of pre-trained processing models, wherein the selection is made, for example, on the basis of context information, is made automatically, or is selected by a user, and the set of processing models is preferably kept available locally at a user's facility, is based on a model catalog from the manufacturer or is kept available online by the manufacturer, and the processing model has been trained in particular according to a train method for training a machine learning system with a processing model, wherein the processing model is trained to assign a result class to signal series from image areas of an image series, the image series is generated by marking analytes with markers in a plurality of coloring rounds and detects the markers with a camera, the camera acquires an image of the image series in each coloring round, the markers are selected in such a way that the signal series of analytes in an image area across the image series comprise colored signals and uncolored signals, the colored and uncolored signals of the signal series of analytes have at least one particular ratio of one of the colored and/or uncolored signals of the respective signal series to at least one other of the colored and/or uncolored signals of the respective signal series, and/or the signal series of analytes have a characteristic signature comprising the at least one particular ratio, comprising:
providing an annotated data set, wherein the annotated data set comprises signal series for different result classes to be identified, as well as corresponding target outputs, the result classes comprise at least one class for each analyte type to be identified, and signal series of analytes have a specific sequence of colored and uncolored signals, from which an analyte type can be assigned to the signal series, and
optimizing an objective function by adjusting the model parameters of the processing model, wherein the objective function is calculated based on a result output from the processing model and the target output.

66. Evaluation device for evaluating images of an image series, which is designed in particular as an analyte data evaluation system, comprising the means for carrying out the method according to claim 1.

67. Image processing system comprising an evaluation device according to the preceding claim 66, in particular comprising an image generation device such as a microscope.

68. Computer program product comprising instructions which, when the program is executed by a computer, cause the computer to execute the method according to claim 1, the computer program product being in particular a computer-readable storage medium.

69. Analyte data evaluation system comprising an evaluation device, wherein the evaluation device comprises a processing model that has been trained using the method according to claim 1, in particular comprising an image generation device such as a microscope.
